(19) United States
(12) Patent Application Publication
(10) Pub. No.: US 2011/0300447 A1
(43) Pub. Date: Dec. 8, 2011

(54) Carbon Coated Anode Materials

(75) Inventor: Lynden A. Archer, Ithaca, NY (US)

(73) Assignee: CORNELL UNIVERSITY, Ithaca, NY (US)

(21) Appl. No.: 13/129,610

(22) PCT Filed: Nov. 18, 2009
(86) PCT No.: PCT/US09/65022

§ 371 Date: Jul. 25, 2011

Related U.S. Application Data
(60) Provisional application No. 61/115,616, filed on Nov. 18, 2008.
(60) Provisional application No. 61/115,600, filed on Nov. 18, 2008.

(51) Int. Cl. H01M 4/48; H01M 4/04

(52) U.S. Cl. 429/231.8; 252/182.1; 216/83; 428/402

(57) ABSTRACT

Nano-colloids of near monodisperse, carbon-coated SnO₂ nano-colloids. There are also carbon-coated SnO₂ nanoparticles. There are also SnO₂/carbon composite hollow spheres as well as an anode of a Li-ion battery having the nano-colloids. There is also a method for synthesizing SnO₂ nano-colloids. There are also coaxial SnO₂@carbon hollow nanospheres, a method for making coaxial SnO2@carbon hollow nanospheres and an anode of a Li— ion battery formed from the coaxial SnO2@-carbon hollow nanospheres.

### CROSS-REFERENCE TO RELATED APPLICATIONS

The present application claims priority based on U.S. Provisional Application No. 61/115,600, filed Nov. 18, 2008, and U.S. Provisional Application No. 61/115,616, filed Nov. 18, 2008, both of which are incorporated herein by reference in their entirety.

### BACKGROUND OF THE INVENTION

1. Field of the Invention

The present invention relates to carbon-coated SnO₂ nano-colloids and coaxial SnO₂@carbon nanospheres. The present invention also describes anodes of a Li-ion battery coated with either SnO₂ nano-colloids or the coaxial SnO₂@carbon nanospheres.

2. Description of the Related Art

Lithium-ion batteries (LIBs) are unmatched among energy storage technologies in terms of power density per unit volume or per unit mass. Tarascon et al. Nature:414359 (2001); Idota et al. 276:1395 Science (1997), Hassoun et al., Adv. Mater., 19:1632 (2007), Nam et al., Science 312:885 (2006), Taberna et al. Nat. Mater. 5:567 (2006) and Kang et al. Science 311:977 (2006). SnO₂-based nanostructured materials are attracting growing research attention as high-capacity negative electrodes for LIBs for a variety of reasons, including their high theoretical capacity, low-cost, low toxicity, and widespread availability. Idota et al. 276:1395 Science (1997) In a SnO₂-based LIB electrode two principal electrochemical processes occur: SnO₂+4Li⁺+4e⁻→Sn+2Li₂O (1); Sn+xLi⁺+xe⁻ [symbol] LiₓSn (0≦x≦4.4) (2). The first reaction is irreversible, and leads to an initial fall-off in capacity of the electrode during the first few charge-discharge cycles. The second process is reversible, and by cycling between the alloyed, LiₓSn, and de-alloyed, Sn, states lithium can be repeatedly released and stored. The theoretical reversible lithium storage capacity for the second reaction is readily calculated to be 790 mA h/g, which is more than twice the theoretical capacity, 372 mA h/g, for currently used graphite. Idota et al. 276:1395 Science (1997), Hassoun et al., Adv. Mater., 19:1632 (2007), Derrien et al. Adv. Mater., 19:2336 (2007), Park et al. Angew. Chem. Int. Ed., 46:750 (2007), Noh et al. Chem. Mater., 17:1926 (2005).

Despite their superior theoretical storage capacity, SnO₂-based anodes have underperformed as LIB anodes. This is readily traced to their poor capacity retention over extended charge/discharge cycling. Tarascon et al. Nature:414359 (2001). The extremely large volume change produced by the alloying reaction with Li (e.g., the volume change is about 250% when Sn alloys with Li to form Li_{4.4}Sn), Larcher et al., J. Mater. Chem., 17:3759 (2007), is widely believed to be the source of this behavior. Specifically, these large cyclic volume changes are believed to create commensurately large cyclic stresses in the SnO₂ anode materials leading fatigue failure and disintegration of the active material. This so-called pulverization problem causes a break down in electrical contact pathways between adjacent particles, leading to rapid capacity fading. Tarascon et al. Nature, 41:4359 (2001).

Because the source of pulverization is of fundamental electrochemical origin, its mitigation has proven quite difficult. One strategy is to design the nanostructure of electrode materials. Hassoun et al., Adv. Mater., 19:1632 (2007), Tabema et al. Nat. Mater. 5:567 (2006), Guo et al. Adv. Mater., 19:2087 (2007). For example, if the SnO₂ anode is comprised of hollow and/or porous nanostructures, the local empty space in the structures can partially accommodate the large volume change, delaying capacity fading. Larcher et al., J. Mater. Chem, 17:3759 (2007); Derrien et al., Adv. Mater., 19:2336 (2007); Noh et al. Chem. Mater. 17:1926 (2005); Wang et al., Adv. Mater., 18:645 (2006); Lou et al. Adv. Mater, 20:258 (2008); Ma et al. Adv. Mater, 19, 4067 (2007); Han et al., Adv. Funct. Mater. 15:1845 (2005); Lou et al. Adv. Mater. 20:1853 (2008); Lee, et al., J. Am. Chem. Soc. 125:5652 (2003); Zhang et al., Adv. Mater. 20:1160 (2008); Wen et al. Adv. Funct. Mater, 17:2772 (2007); Ng et al., Angew. Chem. Int. Ed., 45:6896 (2006); Park et al., Chem. Mater., 19:2406 (2007); Fan et al., Electrochem. Solid State Lett., 10:A274 (2007).

Another commonly used approach is to make use of nanocomposite materials (e.g., the inactive/active concept). Tarascon et al. Nature:414359 (2001). In particular, nano-painting with carbon has recently been found effective for improving cyclability, where carbon functions as a physical buffering layer for the large volume change (cushion effect). Derrien et al. Adv. Mater., 19:2336 (2007), Park et al. Angew. Chem. Int. Ed., 46:750 (2007), Noh et al. Chem. Mater., 17:1926 (2005); Wang et al., Adv. Mater., 18:645 (2006); Lou et al. Adv. Mater, 20:258 (2008); Wen et al. Adv. Funct. Mater, 17:2772 (2007); Ng et al., Angew. Chem. Int. Ed., 45:6896 (2006); Park et al., Chem. Mater., 19:2406 (2007). For example, the recent commercial SONY tin-based anode has been characterized by Whittingham and coworkers to be basically composed of amorphous SnCo nanoparticles coated with graphitic carbon. Fan et al. Electrochem Solid State Lett. 10 A274 (2007). Despite the physical appeal of these procedures, our recent studies show that either design strategy alone leads to only limited improvement in cyclability of SnO₂-based anode materials. Lou et al. Adv. Mater. 18:2325 (2006); Lou et al. Chem. Mater. 20:6562 (2008).

A new type of nano-architecture, coaxial SnO₂@carbon hollow nanosphere is described. Anodes comprised of this structure exhibit exceptional cycling performance and charge-rate capabilities. SnO₂ nano-colloids exhibiting similar improved properties over the art are also described. A simple green-chemical method for large-scale synthesis of nearly monodisperse SnO₂ hybrid particles coated selectively with/without carbon is also described. The procedure utilizes widely available stannates and glucose as precursors. Glucose not only mediates the rapid precipitation of colloidal SnO₂ particles, but also serves as a carbon precursor for SnO₂@carbon core-shell particles.

### SUMMARY OF THE INVENTION

The invention describes nano-colloids, comprising carbon-coated SnO₂ nano-colloids. The nano-colloids may be monodisperse or polydisperse and may comprise two carbon shells. The carbon may be derived from a polysaccharide such as glucose. An anode from a Li-ion battery may be coated with the nano-colloids. The nano-colloids may be spherical in shape and have a diameter ranging from about 150 nm to about 400 nm.

A method of synthesizing SnO₂ nano-colloids is also disclosed, comprising the steps of (a) dissolving potassium stannate in a glucose solution; (b) heating the glucose solution to a temperature ranging from about 160° C. to about 200° C. for about 2 hours to about 8 hours to obtain a powder; and (c) carbonizing the powder by heating to a temperature ranging from about 450° C. to about 700° C. for about 2 hours to about 8 hours. Carbonizing may be done under N₂. The glucose solution can have a concentration ranging from about 0.2 M to about 1.0 M or from about 0.5 M to about 0.8 M.

The invention also discloses coaxial SnO₂@carbon hollow nanospheres, comprising a hollow SnO₂ shell having an outer shell of carbon. The carbon is derived from a polysaccharide such as glucose. The SnO₂ shell may be a double shell of SnO₂.

A method for making the coaxial SnO2@carbon hollow nanospheres is also disclosed, comprising the steps of: (a) synthesizing substantially monodisperse silica nanospheres; (b) coating SnO₂ double-shells on the silica nanospheres; (c) coating the SnO₂@silica with a polysaccharide such as glucose; (d) carbonizing the glucose under an inert atmosphere; and (e) removing the silica nanospheres by addition of acid or base. The silica nanospheres are removed by addition of NaOH or HCl. An anode of a Li-ion battery may be coated with a plurality of coaxial SnO2@carbon hollow nanospheres.

The mesoporous SnO₂ hollow nanospheres can have pores ranging from about 3 nm to about 5 nm in diameter.

### DESCRIPTION OF THE FIGURES

FIG. 1(a) is an TEM image as-synthesized SnO₂ nano-colloids coated with a thin layer of glucose-derived carbon-rich polysaccharide (180° C., 0.8 M glucose).

FIG. 1(b) is an TEM image as-synthesized SnO₂ colloids with no coating of carbon materials observed (160° C., 0.8 M glucose).

FIG. 1(c) carbon-coated SnO₂ nano-colloids obtained after carbonization of particles shown in FIG. 1(a) at 450° C.

FIG. 1(d) is a magnified FESEM image of the rectangular area indicated in FIG. 1(c).

FIG. 1(e) provides a digram of a typical Lithium-ion battery.

FIG. 2 is a plot of a TGA curve of carbon-coated SnO₂ nano-colloids shown in FIGS. 1(c) and 1(d).

FIG. 3 is a collection of XRD patterns. Plot (a) is an XRD of as-synthesized SnO₂ nano-colloids coated with carbon-rich material (180° C., 0.8 M glucose). Plot (b) is an XRD of the nanocolloids after carbonization at 450° C. Plot (c) is an XRD of the nanocolloids after calcination in air at 500° C. for 1 hour.

FIG. 4(a) is FESEM (a, c) and TEM (b, d) images of SnO₂ nano-colloids obtained after calcination in air at 400° C.

FIG. 4(b) is TEM (a, c) and TEM (b, d) images of SnO₂ nano-colloids obtained after calcination in air at 400° C.

FIG. 4(c) is FESEM (a, c) and TEM (b, d) images of SnO₂ nano-colloids obtained after calcination in air at 500° C.

FIG. 4(d) is TEM (a, c) and TEM (b, d) images of SnO₂ nano-colloids obtained after calcination in air at 500° C.

FIG. 5(a) shows a first-cycle discharge-charge voltage profile of the carbon-coated SnO₂ nano-colloids depicted in FIG. 1(c) at a current density of 120 mA/g.

FIG. 5(b) shows a cyclic voltammogram for first and second cycles between 2 V and 5 mV at a scan rate of 0.1 mV/s.

FIG. 5(c) shows a plot of discharge capacity (lithium insertion) versus cycle number between 2 V and 5 mV.

FIG. 6(a) is an TEM image of carbon-coated SnO₂/Sn nanospheres obtained after carbonization at 550° C.

FIG. 6(b) is a FESM image of carbon-coated SnO₂/Sn nanospheres obtained after carbonization at 550° C.

FIG. 6(c) is a TEM image of carbon hollow nanospheres obtained after carbonization at 700° C.

FIG. 6(d) a TEM image of carbon-coated Sn nanospheres obtained after H₂ reduction at 550° C.

FIG. 7 is a collection of XRD patterns. Plot (a) is an XRD of as-synthesized SnO₂/polysaccharide nanospheres (180° C., 1.0 M glucose). Plot (b) is an XRD of the nanocolloids after carbonization at 550° C. Plot (c) is an XRD of the nanocolloids after H₂ reduction at 550° C.

FIG. 8 shows TGA curves for the following: plot (a) corresponds to the carbon-coated SnO₂/Sn nanospheres shown in FIG. 6(a); plot (b) corresponds to the carbon-coated Sn nanospheres shown in FIG. 6(d).

FIG. 9(a) shows first-cycle discharge-charge voltage profiles for SnO₂@carbon (I, see FIG. 6(a)) and Sn@carbon (II, see FIG. 6(d)).

FIG. 9(b) shows discharge capacities (lithium storage) versus cycle number between 2 V and 5 mV at the same current density of 120 mA/g.

FIG. 10 is a schematic of the formation sequence for SnO₂@carbon coaxial hollow spheres.

FIG. 11(a) shows an FESEM image of SnO₂@carbon hollow spheres of Example 3.

FIG. 11(b) shows an FESEM image of SnO₂@carbon hollow spheres of Example 3.

FIG. 11(c) shows a TEM image of SnO₂@carbon hollow spheres of Example 3.

FIG. 11(d) shows a TEM image of SnO₂@carbon hollow spheres of Example 3.

FIG. 11(e) shows FESM of SnO₂@carbon hollow spheres of Example 3.

FIG. 11(f) shows TEM SnO₂@carbon hollow spheres of Example 3.

FIG. 12(a) shows Cyclic voltammograms of SnO₂@carbon coaxial hollow spheres of Example 3 depicting the first two cycles between 3 V and 5 mV at a scan rate of 0.05 mV/s.

FIG. 12(b) shows capacities versus cycle number between 2 V and 5 mV at a 0.8 C rate for the spheres of Example 3.

FIG. 12(c) shows cycling performance of the same cell at various rates after cycled for 100 cycles shown in FIG. 12(b) for the spheres of Example 3.

FIG. 13 shows XRD patterns of SnO₂ (a) and SnO₂@carbon (b) hollow spheres of Example 3 after dissolving silica templates in 2M NaOH at 50° C.

FIG. 14 shows a TGA curve in air flow of 60 mL/min with a temperature ramp of 3° C./minute for the spheres of Example 3. The weight loss below 150° C. rises primarily from water evaporation since the sample is found not completely dry.

FIG. 15 shows a low-magnification FESEM image of SnO₂ hollow spheres of Example 3 after dissolving silica templates in 2M NaOH with the broken ones indicated by white frames.

FIG. 16 shows a plot of a typical discharge-charge voltage profile for the first cycle at a current density of 0.32 C for the spheres of Example 3.

FIG. 17 shows a plot of the cycling performance of SnO₂@carbon hollow spheres of Example 3 measured between 3 V and 5 mV at a current density of 0.8 C for the spheres.

FIG. 18 shows a plot comparing cycling performances between SnO₂ and SnO₂@carbon hollow spheres of Example 3 under the same testing conditions.

FIG. 19 shows a schematic illustration of the synthetic procedure for making SnO₂/carbon composite hollow spheres, and derived carbon double-shelled hollow spheres.

FIG. 20(a) shows an SEM of the SnO₂ hollow nanospheres in Example 4.

FIG. 20(b) shows an SEM of the SnO₂ hollow nanospheres in Example 4.

FIG. 20(c) shows a TEM of the SnO₂ hollow nanospheres of Example 4.

FIG. 20(d) shows a TEM of the SnO₂ hollow nanospheres of Example 4.

FIG. 20(e) shows an N₂ adsorption-desorption isotherm at 77 K for the SnO₂ hollow nanospheres of Example 4.

FIG. 20(f) shows corresponding pore size distributions calculated by BJH method from both branches for the SnO₂ hollow nanospheres of Example 4.

FIG. 21 shows XRD patterns of SnO₂ hollow nanospheres (a) and SnO2/carbon composite hollow spheres (b) of Example 4.

FIG. 22(a) shows an SEM image of a SnO₂/carbon composite hollow spheres of Example 4.

FIG. 22 (b) shows a TGA curve under air with a ramp of 10° C./minute of a SnO2/carbon composite hollow spheres of Example 4.

FIG. 22 (c) shows a TEM image of a SnO₂/carbon composite hollow spheres of Example 4.

FIG. 22 (d) shows a TEM image of a SnO₂/carbon composite hollow spheres of Example 4.

FIG. 22 (e) shows a TEM image showing double-shelled carbon hollow spheres after focused electron beam irradiation.

FIG. 22 (f) shows a TEM image showing double-shelled carbon hollow spheres after focused electron beam irradiation with some remaining Sn nanoparticles indicated by black arrows.

FIG. 23(a) shows a discharge-charge voltage profiles of SnO₂/carbon composite hollow spheres for 1⁵¹ and 2^{nd} cycles at a current density of 100 mA/g.

FIG. 23(b) shows a cycling performance of SnO₂/carbon composite hollow spheres at a current density of 100 mA/g and SnO2 hollow nanospheres at a current density of 160 mA/g.

### DETAILED DESCRIPTION OF THE INVENTION

Two types of nanoparticles are encompassed by the methods and compositions of the present invention. The first type of particle is carbon-coated SnO₂ nano-colloid. The nano-colloids may be monodisperse or polydisperse and may comprise two carbon shells. The carbon may be derived from a polysaccharide such as glucose. An anode from a Li-ion battery may be coated with the nano-colloids. The nano-colloids may be spherical in shape and have a diameter ranging from about 150 nm to about 400 nm. The carbon-coated SnO₂ nano-colloid may be SnO₂/carbon composite hollow spheres which is prepared by a template-free route based on an inside-out Ostwald ripening mechanism. Lou et al., Adv. Mater. 18:2325 (2006). Since the hollow interior space is created by spontaneous evacuation of the interior materials through the shell, the shell is highly porous.

A method of synthesizing the SnO₂ nano-colloids may comprise the steps of (a) dissolving potassium stannate in a glucose solution; (b) heating the glucose solution to a temperature ranging from about 160° C. to about 200° C. for about 2 hours to about 8 hours to obtain a powder; and (c) carbonizing the powder by heating to a temperature ranging from about 450° C. to about 700° C. for about 2 hours to about 8 hours. Carbonizing may be done under N₂. The glucose solution can have a concentration ranging from about 0.2 M to about 1.0 M or from about 0.5 M to about 0.8 M.

The synthesis of SnO₂/carbon composite hollow spheres is schematically illustrated in FIG. 19. In step 1, a glucose-derived polysaccharide (PS) carbon precursor is efficiently infiltrated into the mesoporous SnO₂ shells through 3D interconnected “nano-channels” (i.e., pores), and deposited onto both its interior and exterior surfaces. In step 2, the PS is carbonized under inert atmosphere to produce a 3D carbon network in the SnO₂ shell sandwiched by two carbon shells. The SnO₂/carbon mixture is then heated forming a Sn-carbon composite or colloid containing carbon and Sn. Lou et al., Chem. Mater., 20:(20): 6562 (2008), Lou et al, Chem. Mater. 21(13): 2868 (2009). Pores may be introduced into the nano-colloids as described in He et al., Appl. Surf. Sci. 255:183 (2008), Kobayashi et al. Appl. Surf. Sci. 255: 191 (2008) and Gidley et al. Annu Rev. Mater. Res. 36: 49 (2006).

As shown in Examples 1 and 2, the SnO₂ nano-colloids of the present invention are useful as anode materials for lithium-ion (Li-ion) batteries. The carbon-coated SnO₂ nano-colloids of the present invention exhibit significantly improved cycling performance in such anodes as compared to conventional SnO₂-based anodes. The SnO₂/carbon composite hollow spheres of the present invention are made up of a hollow SnO₂ microsphere core and a layer of carbon on the outside surface of the core and optionally another carbon layer inside the core. The SnO₂/carboncomposite hollow spheres are manufactured as discussed below in the examples.

The SnO₂ hollow spheres range in size from about 150 to about 400 nm. In general, the pore size is less than about 5 nm, although other ranges are possible, including from about 3 nm to about 5 nm and about 4 nm. The mesoporous structure has a Brunauer-Emmettt-Teller (BET) specific surface area of at least about 110 m²/g, although higher and lower numbers are also possible. The spheres may be mono or polydisperse.

The second type of nanoparticle encompassed by the present invention is a SnO₂@carbon coaxial hollow nanospheres. The coaxial SnO₂@carbon hollow nanospheres may comprise a hollow SnO₂ shell having an outer shell of carbon. The carbon may be derived from a polysaccharide such as glucose. The SnO₂ shell may be a double shell of SnO₂. An anode of a Li-ion battery may contain or be coated with a plurality of the coaxial SnO2@carbon hollow nanospheres.

A method for making the coaxial SnO2@carbon hollow nanospheres may comprise the steps of: (a) synthesizing substantially monodisperse silica nanospheres; (b) coating SnO₂ double-shells on the silica nanospheres; (c) coating the SnO₂@silica with a polysaccharide such as glucose; (d) carbonizing the glucose under an inert atmosphere; and (e) removing the silica nanospheres by addition of acid or base. The silica nanospheres may be removed by addition of NaOH or HCl. An anode of a Li-ion battery may be coated with a plurality of coaxial SnO2@carbon hollow nanospheres. As used herein, the term “substantially monodisperse” refers to nanospheres that are greater than about 60% monodisperse, greater than about 70% monodisperse, greater than about 80% monodisperse, or greater than about 90% monodisperse.

FIG. 10 provides an outline of the synthetic pathway for these nanoparticles. In step 1, silica nanospheres (ranging in size from about 240 to about 250 nm in diameter) are coated with uniform SnO₂ double shells. Lou et al. Small, 3:261 (2007). The double-shelled architecture increases not only the structural integrity, but also the weight fraction of the electrochemically active component (SnO₂) of the designed component anode. In step 2, these core-shelled silica@SnO₂ nanospheres are further coated with glucose-derived carbon-rich polysaccharide (GCP) by a simple hydrothermal approach. It is well known that such GCP contains abundant hydroxyl groups and can be carbonized at a relatively low temperature under inert conditions. Sun et al. Chem. Mater., 18:3486 (2006). After carbonization, the silica nanospheres are removed in the final step 3 to produce SnO₂@carbon coaxial hollow nanospheres. Lou et al. Adv. Mater. 18:2325 (2006). Park et al. Adv. Funct. Mater. 20:1227 (2008). Lou et al. Chem. Mater. 20:6562 (2008).

These nanospheres may have a variety of pore size openings typically ranging from about 0.1 nm to about 10 nm and more typically from about 0.12 nm to about 6 nm, and most typically from about 0.15 nm to about 0.55 nm. The size of the pores may be the same or different, i.e., the distribution of pore size may have a variety of different distributions, normal, binomial, etc. The pore size may be varied by adjusting the pH of the either the acid or base used to dissolve or remove the silica core. Silica nanospheres may be synthesized in a wide range of sizes (ranging from about 5 nm to about 2000 nm) using multiple sol-gel approaches, including the Stober method. Stober et al. J. Colloid Interface Sci: 26: 62 (1968) (see also, Lou et al. Small 2007:3:261. R. K. Iler, The Chemistry of Silica: Solubility, Polymerization, Colloid and Surface Properties, and Biochemistry, Wiley, New York (1979). C. J. Brinker and G. W. Scherer, Sol-Gel Science: The Physics and Chemistry of Sol-gel Processing, Academic, San Diego (1990). Bogush et al., J. Non-Cryst. Solids 104: 95 (1988). Green et al., Journal of Colloid and Interface Science: 266, 346 (2003)).

The methods of the present invention are also useful for large-scale synthesis of monodisperse SnO₂ nano-colloids coated selectively with/without carbon using inexpensive stannate and one or more PS, e.g., glucose, as precursors. It should be noted that the nano-colloids may be polydisperse, i.e., have an uneven shape distribution. Glucose not only mediates the rapid precipitation of colloidal SnO₂ particles, but also serves as a carbon precursor for SnO₂@carbon core-shell particles.

Glucose-derived polysaccharides (PS) or carbon-derived materials are useful as carbon precursors in the method of the present invention. Examples of PS include, but are not limited to, the following: glucose, fructose, maltose, lactose, dextrose, sucrose, or other polysaccharides; a preferred polysaccharide (PS) is glucose. However, any water or alcohol dispersable carbon source may be used. The PS are employed in the form of a solution in a solvent such as water in which the PS is soluble. Aqueous solutions of PS, especially glucose, in the range from about 0.2 M to about 1 M and preferably about 0.5 M to about 0.8 M may be used, although both higher and lower ranges may be used as well, e.g., ranging from about 0.01 M to about 0.2 M and from 0.8 M to about 8 M. Other examples of carbon-derived materials include, polyacrylonitrile (PAN) and its water-dispersable copolymers, citric acid, gallic acid, and fumaric acid.

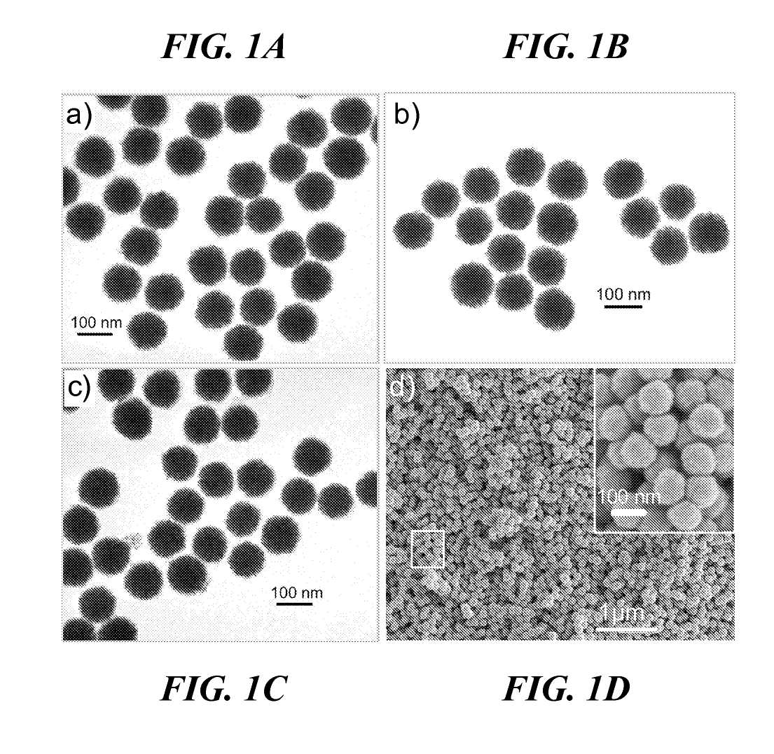

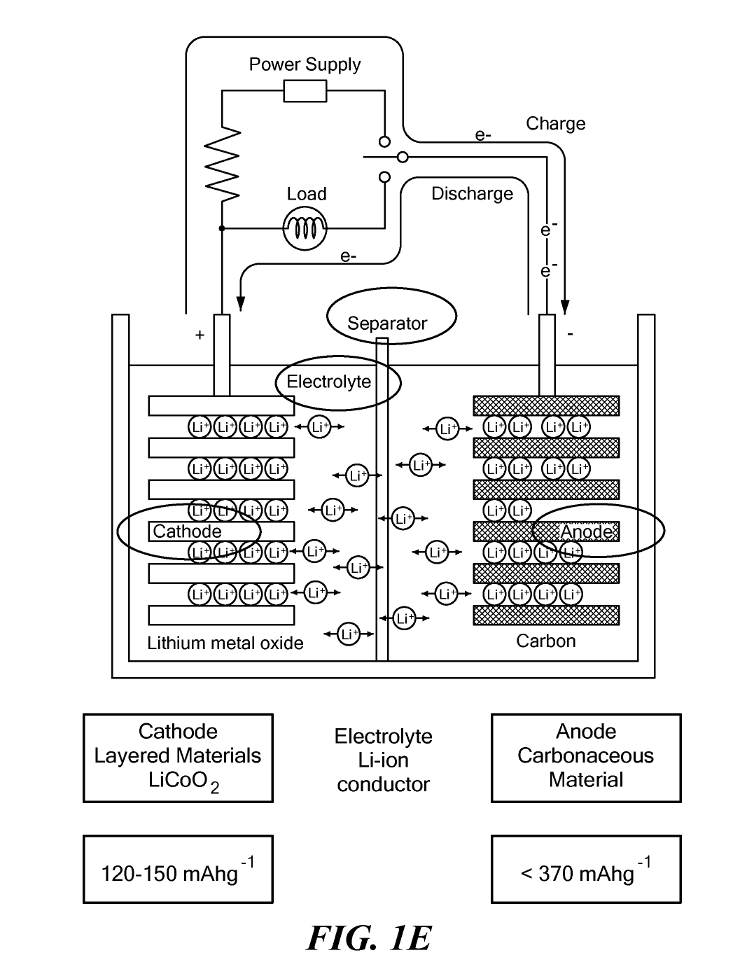

Either type of nanoparticle may be coated on an anode in a Li-ion battery by coating, spraying, dipping electroplating or other well known procedures in the art. Yoshio et al., Lithium Ion Batteries, Springer, N.Y. (2009). A Li-ion battery may comprise either type of nanoparticle. A general diagram of a Lithium-ion battery is shown below in FIG. 1(e).

Although monodisperse nano-colloids and spheres are described, the material may be polydisperse, having a variety of different size distributions. In addition, while spherical particles are mentioned, the geometry of the particles may vary from a cube, sheet, rhomboid to encompass a wide range of different geometries as well as size distributions.

The following provides examples of the present invention and are not to be construed as limiting.

### EXAMPLES

### Examples 1 and 2

Carbon-coated SnO₂ nano-colloids were synthesized in large scale by a simple hydrothermal method followed by carbonization under inert atmosphere. The resulting nanocolloids may be monodisperse, i.e., having the same size, or polydisperse. The overall structure and synthetic pathway of the carbon-coated SnO₂ nano-colloids is shown in FIG. 19 (see, Wen et al., Hollow Micro-/Nanostructures:Synthesis and Applications, Adv. Matter, 20:1-33 (2008)).

### Materials Preparation

1.0 gram of potassium stannate trihydrate (K₂SnO₃.3H₂O, Aldrich, 99.9%) was dissolved in 20 mL of 0.8 M (concentrations in the range of about 0.2 to about 1.0 M were investigated) aqueous glucose solution. Other molar concentrations of glucose may be used, including from about 0.01M to about 0.2 and from about 0.5 M to about 8M and from about 1.0 M to about 8 M may also be used. Afterwards, the solution was transferred to a Teflon-lined stainless steel autoclave (40 mL in volume) and hydrothermally treated in an air-flow electric oven at 180° C. (temperatures in the range of 160° C.-200° C. were investigated) for 4 hours. The times may also range from about 2 hours to about 8 hours, from about 4 to about 8 hours and from about 6 to about 8 hours. After cooling down naturally, the dark-grey precipitate was harvested by centrifugation and washed thoroughly with ethanol and deionized water. After vacuum-drying at room temperature, about 0.75 gram of brown-grey powder was obtained. For carbonization, the powder was loaded into a tube furnace and heated under high-purity N₂ at 450° C. (temperatures in the range of 450° C.-700° C. were also investigated and found to work for 4 hours with a temperature ramp of 4° C./minute (carbonization may also be for about 2 to about 6 g hours and for about 4 to about 6 hours). For reduction with H₂, a mixed H₂/N₂ (6% H₂) gas flow was used instead of pure N₂ gas. To burn off the carbon material, the brown-grey powder was calcined in air at about 350° C. to about 500° C. for about 1 hour.

### Materials Characterization

Products were characterized with X-ray powder diffraction (XRD; Scintag PAD X, Cu Kα, λ=1.5406 Å), field emission scanning electron microscopy (FESEM; Hitachi S4500), and transmission electron microscopy (TEM; JEOL-1200EX, 120 kV). The thermogravimetric analysis (TGA) was carried out under an air flow of 60 mL/minute using TA Instruments Q500 from room temperature to 550° C. with a heating rate of 3° C./min.

### Electrochemical Measurement

Electrochemical measurements were carried out using homemade two-electrode Swagelok-type cells with lithium metal as the counter and reference electrodes at room temperature. The working electrode consisted of 80 wt % of the active material (e.g., SnO₂@C), 10 wt % of conductivity agent (carbon black, Super-P-Li), and 10 wt % of binder (polyvinylidene difluoride, PVDF, Aldrich). The active material loading in each electrode disc (about 13 mm in diameter) was typically 1-2 mg. The electrolyte was 1 M LiPF₆ in a 50:50 w/w mixture of ethylene carbonate and diethyl carbonate. Cell assembly was carried out in a Argon-filled glove box with the concentrations of moisture and oxygen below 1 ppm. Charge-discharge cycles of the half-cells were measured between 5 mV and 2.0 V (or 3.0 V) at a constant current density with a Maccor 4304 battery tester.

### Results

Uniform-sized carbon-coated SnO₂ nano-colloids were synthesized in large scale using inexpensive stannate and glucose as precursors (note, nonuniform nanocolloids may also be used). The synthesis is based on a hydrothermal method followed by carbonization under inert atmosphere. FIG. 1(a) displays as-synthesized SnO₂ nano-colloids coated with a thin layer of GCP under hydrothermal conditions at 180° C. As can be seen, these discrete core-shell nano-colloids are nearly monodisperse with a diameter of about 100 nm. Each individual SnO₂ colloid is composed of numerous fine nanoparticles. Although synthesized by a one-pot process (single vessel), such core-shell nano-colloids are formed by hydrolysis of stannate and subsequent deposition of GCP because of the difference in reaction kinetics. SnO₂ nano-colloids synthesized at 160° C. did not appear to have as notable GCP coating as shown in FIG. 1(b). Formation of SnO₂ nanospheres can be mediated by using a mild acidic condition created as a result of hydrothermal treatment of glucose. When the glucose concentration is increased to 0.5 M, the product consisted of small nanoparticles and nanospheres with a broad size distribution and moderate yield (note, the symbol @ refers to coating with the term following the @). Monodisperse SnO₂@GCP nano-colloids were obtained with nearly perfect yield when the glucose concentration was about 0.8 M. FIG. 1(a).

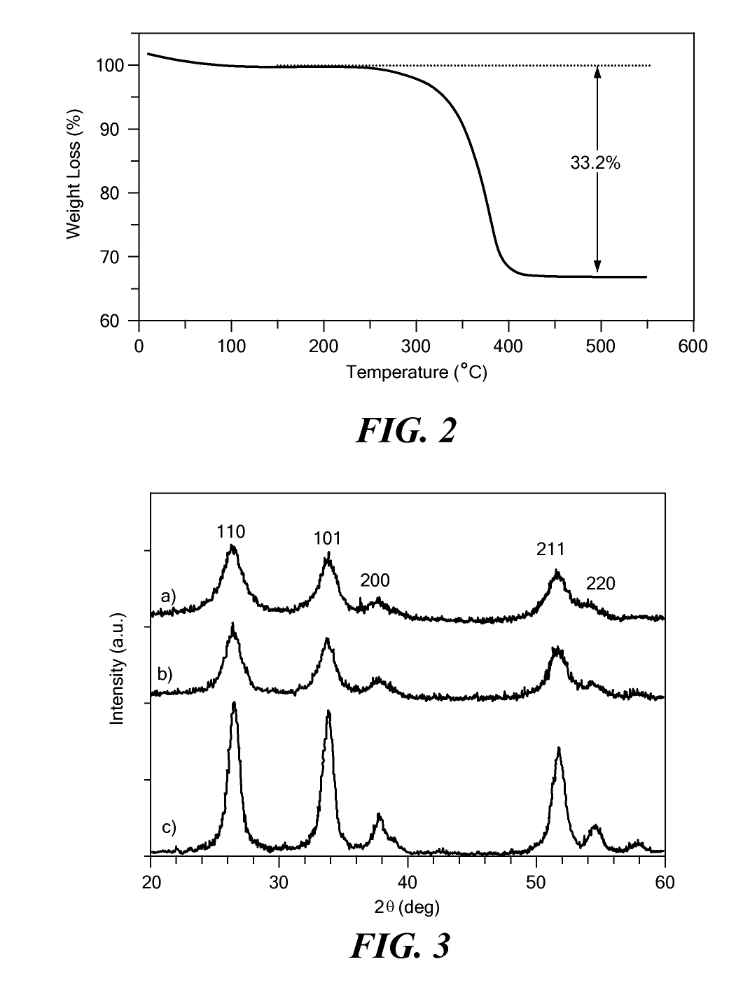

GCP can be carbonized at a temperatures as low as 400° C. FIGS. 1(c) and 1(d) show carbon-coated SnO₂ nano-colloids obtained by carbonizing the as-synthesized SnO₂@GCP nano-colloids at 450° C. As can be seen, the morphology is largely unaltered. The carbon content in these carbon-coated SnO₂ nano-colloids can be readily determined by thermo-gravimetric analysis (TGA). As shown in TGA curve in FIG. 2, the combustion of carbon begins around 260° C., and is nearly complete around 400° C. (In FIG. 2, the weight is normalized at 100° C. since the weight loss below 100° C. is mainly caused by water evaporation). This temperature is far too low for carbothermal reduction of SnO₂ and the weight loss below 100° C. is generally attributed to evaporation of adsorbed water. Therefore, the carbon content is directly read from the TGA curve to be about 33.2 wt % in this example.

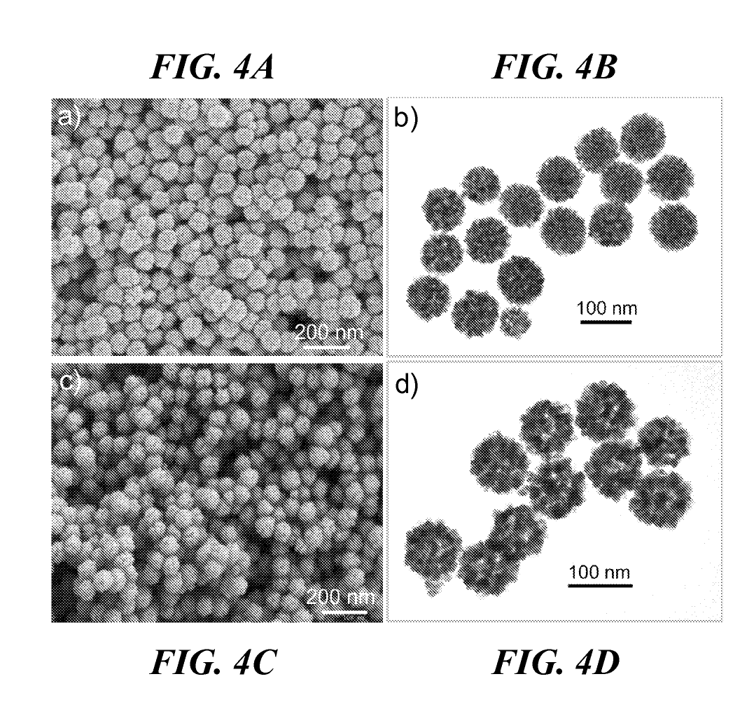

The crystallographic structure of all samples was characterized by x-ray powder diffraction (XRD). From the XRD pattern (FIG. 3, plot (a)) of the as-synthesized core-shell nano-colloids, the poorly crystalline phase is assigned to tetragonal rutile SnO₂ (JCPDS card no. 41-1445, space group: P4₂/mnm, aₒ=4.738 Å, cₒ=3.187 Å) and noting that GCP is amorphous. The mean crystallite size is estimated to be about 4 nm only using Scherrer's formula based on the (110) peak. According to previous reports, carbothermal reduction of SnO₂ becomes substantial only when the carbonization temperature reaches around 600° C. XRD analysis (FIG. 3, plot (b)) confirms that carbothermal reduction of SnO₂ does not take place during carbonization at 450° C. The crystallinity of SnO₂ was almost unchanged with the mean crystallite size increasing slightly to about 5 nm (from Scherrer's formula). Pure SnO₂ nano-colloids could be obtained by calcining as-synthesized SnO₂@GCP core-shell nanospheres in air. From the XRD pattern shown in FIG. 3, plot (c), the crystallinity of SnO₂ was observed to be significantly improved with a mean crystallite size of 9 nm (from Scherrer's formula). FIG. 4 shows the resulting SnO₂ nano-colloids after calcination at 400° C. and 500° C. At higher calcination temperatures, nanospherical morphology is maintained and the crystallite size (compare 4(d) with 4(b)), leading to a more porous structure.

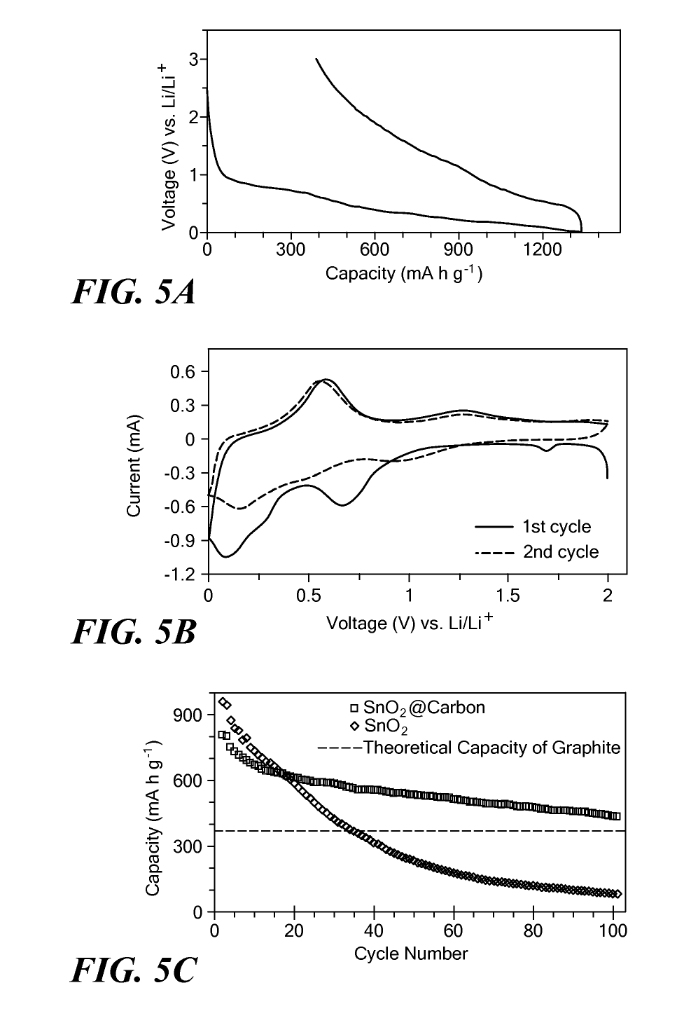

Lithium storage properties were tested using a normal two-electrode cell in which lithium foil serves as both counter and reference electrodes. FIG. 5(a) shows a typical discharge-charge voltage profile of carbon-coated SnO₂ nano-colloids for the first cycle at a current density of 120 mA/g. During initial discharge, the cell potential drops rapidly from the open circuit potential of about 3.2 V. The discharge and charge capacities were observed to be 1337.1 and 948.8 mA h/g, respectively, indicating an irreversible loss of 29% which is compartively small for SnO₂-based materials.

To further understand this irreversible loss, a cyclic voltammetry (CV) measurement was carried out, with the result shown in FIG. 5(b). Two well-defined cathodic peaks were observed in the first cycle. The peak at 0.66 V corresponded to the reductive transformation of SnO₂ to Sn and Li₂O (SnO₂+4Li--->Sn+2 Li₂O (reaction (1)), while the peak at 0.07 V can be attributed to formation of Sn+xLi--->LiₓSn alloy (reaction (2)) and insertion of Li into the carbon materials. Two corresponding anodic peaks were observed. One was at about 0.6 V, which indicates de-alloying of LiₓSn alloy. The other peak was at about 1.28 V, which might indicate partial reversibility of reaction (1). In the second cycle, both cathodic peaks shifted to higher voltages (about 0.14 V and 1.0 V), and the peak current decreased substantially. This result indicates occurrence of irreversible processes during the first cathodic sweep. Apart from the largely irreversible reaction (1), irreversible decomposition of electrolyte could occur at low voltages (for example, formation of solid electrolyte interface (SEI)). There is no noticeable current change at both anodic peaks, which suggests that the alloying/de-alloying reaction between Sn and Li takes place to the same extent. In other words, the reaction is highly reversible (otherwise, a significant reduction in anodic peaks during 2^{nd} cycle would be observed). Reversibility from cathodic and anodic peaks in the same cycle might be possible.

FIG. 5(c) shows the cycling performance of the carbon-coated SnO₂ nano-colloids. The current densities used for SnO₂@Carbon and SnO₂ (see FIG. 4d) are 300 and 400 mA/g, respectively, by taking the carbon mass of SnO₂@Carbon into account. The capacity retention significantly improved compared to cycling performance of previously known SnO₂-based materials. Specifically, while the capacity still decayed gradually over cycling, a high capacity of 440 mA h/g could be retained over at least 100 cycles at a current density of 300 mA/g. Higher cycling performances such as 500, 1000, 2000, 4000, 6000, and 10000 cycles are encompassed within the scope of this invention.

For comparison, the cycling performance of SnO₂ nanospheres obtained by calcination at 500° C. is also provided in FIG. 5(c). The capacity of SnO₂ nanospheres faded quickly to a value below the theoretical capacity of graphite (372 mA h/g) in less than 40 cycles and to 87 mA h/g only after 100 cycles. The above results clearly indicate the positive impact of carbon nanocoating on capacity retention over extended cycling.

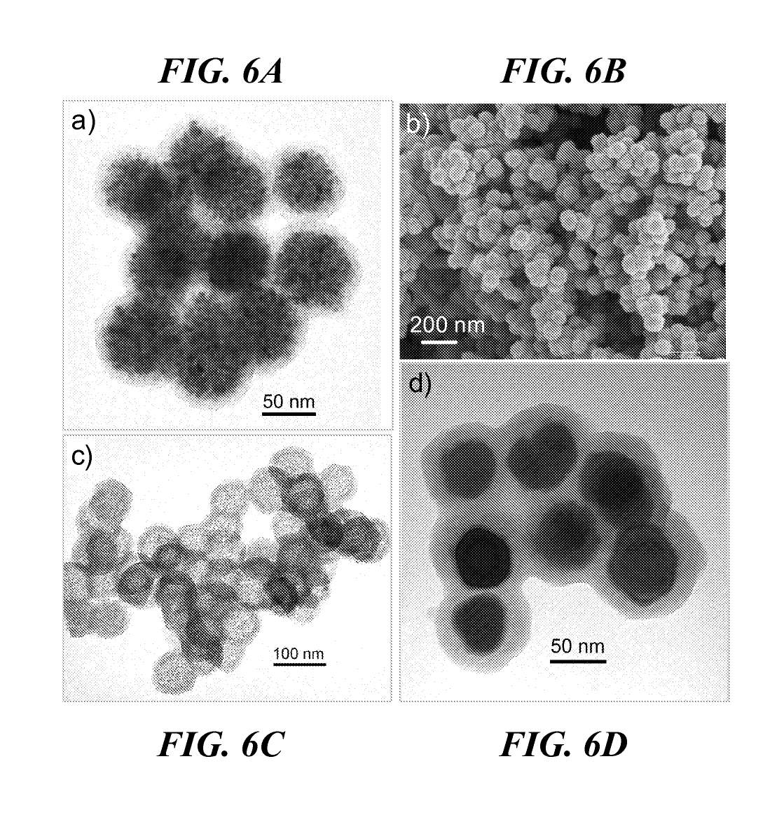

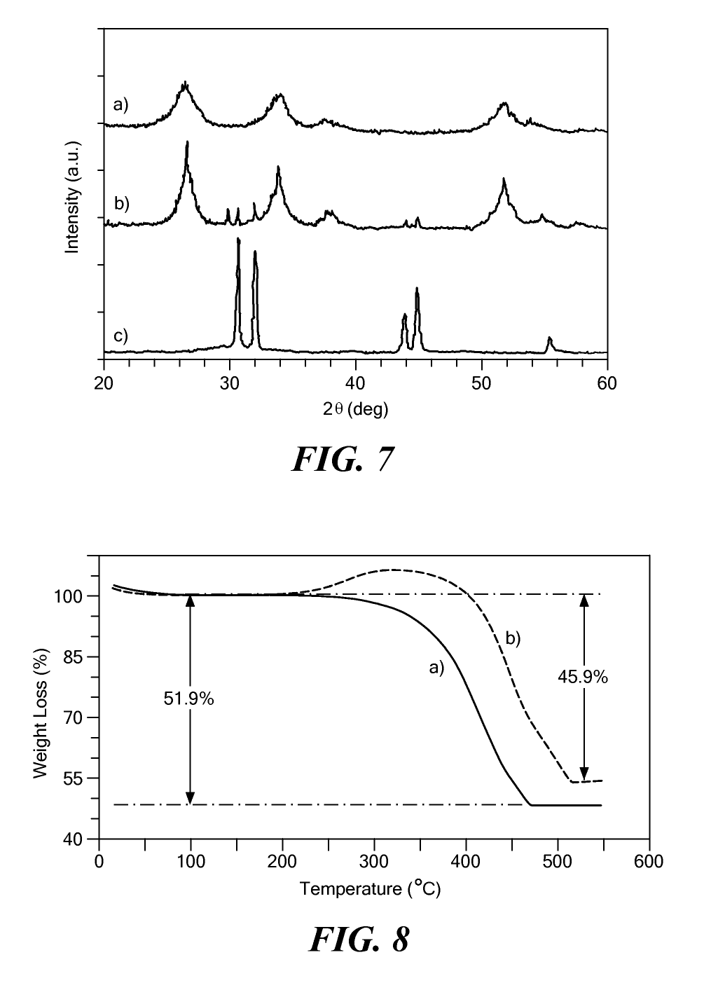

When glucose concentration was further increased to 1.0 M, the GCP coating becomes more predominant, i.e., the particles were largely interconnected by the thick GCP coating. FIGS. 6(a) and 6(b) show particles synthesized with a glucose concentration of 1.0 M and carbonized at 550° C. The SnO₂/polysaccharide nanospheres were synthesized at 180° C. with a glucose concentration of 1.0 M. As can be seen from FIG. 6(a), the SnO₂ nanospheres were completely embedded in thick carbon shells. From the corresponding XRD analysis (FIG. 7(b)), carbothermal reduction took place to a small extent as suggested by the emerging small peaks (compared to FIG. 7(a)), which can be assigned to SnO and Sn. When carbonization was carried out at 700° C., XRD analysis revealed that SnO₂ was completely reduced to metallic Sn, which, because of its very low melting point (232° C.), evaporated to form big beads in micrometer or even millimeter size. As a result, abundant carbon hollow nanospheres were produced as shown in FIG. 6(c).

Thus, there is a need for another approach. Specifically, we included a small fraction of H₂ gas to reduce SnO₂ during carbonization, which was carried out at a lower temperature of 550° C. At this temperature, evaporation of Sn is insignificant. Confirmed by XRD analysis (FIG. 7(c)), polycrystalline SnO₂ was completely reduced to metallic fl-Sn (JCPDS card no. 04-0673). From the TEM image shown in FIG. 6(d), the as-formed Sn nanospheres are still confined inside the carbon shell. Because of significant shrinkage of GCP during carbonization, it appeared that the Sn nanospheres were tightly wrapped by the carbon shells. Again, the carbon content in both SnO₂@carbon and Sn@carbon samples can be determined by TGA. For the plots in FIG. 8, the weight was normalized at 100° C. because the weight loss below 100° C. is mainly caused by water evaporation. From the TGA curve (FIG. 8, plot (a)), it could be directly observed that there was about 51.9% of carbon in the SnO₂@carbon sample since the Sn content was insignificant as suggested by XRD analysis above. For the TGA curve of Sn@carbon (FIG. 8, plot (b)), the initial weight gain in the temperature range of 210° C.-330° C. is due to oxidation of Sn by O₂ forming SnO₂. From the overall weight loss of 45.9%, the carbon content of Sn@carbon can be calculated to be 57.4%, which is in good agreement with 51.9% of carbon in corresponding SnO₂@carbon.

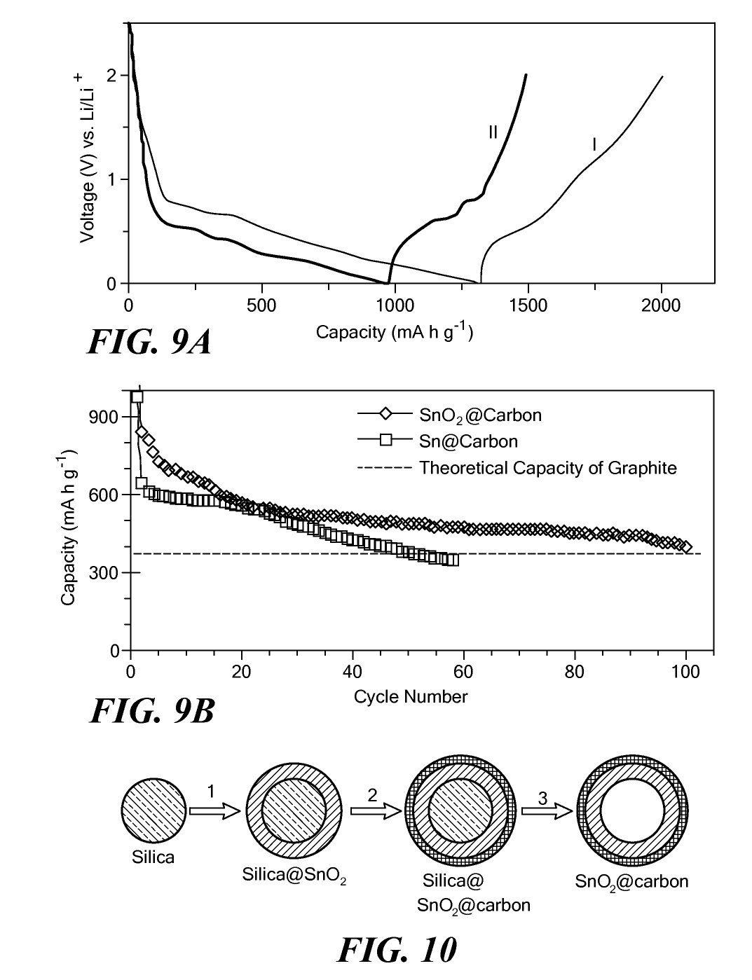

One major drawback of SnO₂-based anode materials is their initial large irreversible loss of lithium, which has heretofore been generally ascribed to the irreversible reduction of SnO₂ to Sn (reaction 1) in the field. The two samples (SnO₂@carbon vs. Sn@carbon) obtained above possess similar structure, morphology and size. Their lithium storage properties were compared. FIG. 9(a) shows the 1^{st}-cycle discharge-charge voltage profiles for both samples. Despite the large difference in the first-discharge capacity (1325 vs. 979 mA h/g), it was surprisingly found that both samples have similar initial irreversible loss after charging to 2 V, namely, 49% vs. 48% for SnO₂@carbon and Sn@carbon respectively. This observation might be explained as follows. On one hand, for SnO₂@carbon the conversion reaction (1) is at least in part reversible as supported by the CV measurement and probably in a similar mechanism as transition metal oxides. This argument will also help explain a common observation that reversible lithium storage capacity of SnO₂ can often be much higher than the theoretical value of 790 mA h/g based on reaction (2) during the first 10 cycles. On the other hand, it might be generally concluded that the large initial irreversible loss could be mainly caused by formation of solid-electrolyte interface (SEI) and decomposition of electrolyte at a low voltage as similarly observed for pure carbon material (see supporting information). Catalytic decomposition of electrolyte by pure Sn crystallites might also be responsible for an anomalous high-voltage (>1.0 V) irreversible capacity observed in Sn electrodes. This possibility, however, can be ruled out in present instance since the capacity contribution above 1.0 V is insignificant.

FIG. 9(b) shows the comparative cycling performance. The initial total capacity of Sn@carbon (around 560-600 mA h/g) was generally consistent with the additive contributions by weight fraction from Sn (about 430 mA h/g) and carbon matrix (about 160 mA h/g). The capacity of Sn@carbon faded gradually to about 560 mA h/g after 20 cycles, then quickly to a value below 372 mA h/g after 52 cycles. This might be understood in view of the structural features of these Sn@carbon nanospheres (see FIG. 6(d)). Specifically, the confined Sn nanospheres of 50-80 nm in size may be too large, and in addition there appears to be no interior hollow space for accommodating the large volume change during discharging-charging cycles. In contrast, each carbon-coated porous SnO₂ nanosphere was composed of numerous small crystallites (see FIG. 6(a)). As a result, the SnO₂@carbon nanospheres can deliver a capacity higher than the theoretical capacity of graphite (372 mA h/g) for at least a 100 cycles. A greater number of cycles may also be possible, including 100, 200, 400, 800, 1600 and 3200 cycles. Higher order of cycling ranges including greater than 50,000 or 100,000 are also possible.

In summary, approximately, monodisperse carbon-coated SnO₂ nano-colloids have been synthesized in gram scale by a hydrothermal method followed by carbonization. When tested for reversible lithium storage, these SnO₂@carbon core-shell nano-colloids manifest significantly improved cycling performance compared to SnO₂ nanospheres. A high capacity of 440 mA h/g can be retained after 100 cycles. The results clearly demonstrate that carbon nano-coating can be an effective way for improving cycling performance of non-carbonaceous anode materials for lithium ion batteries. Carbon-coated Sn nanospheres can also be obtained by reduction of SnO₂ with H₂ at a relatively low temperature. Given the synthetic ease, scalability for mass production, and excellent lithium storage properties, SnO₂ nano-colloids, coated with carbon or uncoated, could be useful in lithium ion batteries, sensors as well as other important applications.

### Example 3

Silica nanospheres (ranging from about 240 to about 250 nm in diameter) were synthesized by the Stober's method. Stober et al., J. Colloid Interface Sci., 26:62 (1968) using the one-pot protocol described in Lou et al., Small, 3:261 (2007). Stober synthesis is the ammonia-catalyzed reactions of tetraethylorthosilicate with water in low-molecular-weight alcohols. This reaction produces nearly monodisperse, spherical silica nanoparticles with sizes ranging from 5-2000 nm. R. K. Iler, The Chemistry of Silica: Solubility, Polymerization, Colloid and Surface Properties, and Biochemistry, Wiley, New York (1979), Brinker et al., Sol-Gel Science: The Physics and Chemistry of Sol-gel Processing, Academic, San Diego (1990), Bogush et al., J. Non-Cryst. Solids 104: 95 (1988) and Green et al., Journal of Colloid and Interface Science 266: 346 (2003). Etching of silica with base or acid is fully detailed in Iler et al., The Chemistry of Silica: Solubility, Polymerization, Colloid and Surface Properties, and Biochemistry, Wiley, New York (1979), Brinker et al., Sol-Gel Science: The Physics and Chemistry of Sol-gel Processing, Academic, San Diego (1990) and Liang et al, Chemistry of Materials, 20:1451 (2008).

### Materials Synthesis

Coating of SnO₂ double-shells on silica nanospheres was done as described by Lou et al. Small, 3:261 (2007). Afterwards, glucose-derived carbon material was coated on SiO₂@SnO₂ by a simple hydrothermal process. In a typical synthesis, 0.3 gram of as-prepared core-shell SiO₂@SnO₂ nanospheres was easily dispersed by ultrasonication in 20 mL of 0.5 M aqueous glucose solution. The suspension was transferred to a 40 mL Teflon-lined autoclave, which was then heated in an air-flow electric oven at 180° C. for 3 hours. The product was harvested by centrifugation and washed with deionized water and ethanol for at least five times. After drying at 50° C., the resulting brown powder was carbonized at 500° C. for 4 hours under inert atmosphere. Finally, SnO₂@carbon coaxial hollow spheres were obtained by dissolving the silica nanotemplates in a 2 M NaOH solution at 50° C. for 8 hours (HCl may also be used).

### Materials Characterization

Products were characterized with x-ray powder diffraction (XRD; Scintag PAD X, Cu Kα, λ=1.5406 Å), field emission scanning electron microscopy (FESEM; Hitachi S4500), and transmission electron microscopy (TEM; JEOL-1200EX, 120 kV, and FEI Tecnai T12, 120 kV). The thermogravimetric analysis (TGA) was carried out under air flow of 60 mL/min using TA Instrument Q500 from room temperature to 550° C. with a heating rate of 3° C./minute.

### Electrochemical Measurement

The electrochemical measurements were carried out using homemade Swagelok-type cells with lithium metal as the counter and reference electrodes at room temperature. The working electrode consisted of active material (e.g., SnO₂@carbon hollow spheres), conductivity agent (carbon black, Super-P-Li), and polymer binder (polyvinylidene difluoride, PVDF, Aldrich) in a weight ratio of around 80:10:10. The active material loading in each electrode disc (about 12 mm in diameter) is typically 1-2 mg, corresponding to about 1.5 mg/cm². The electrolyte was 1 M LiPF₆ in a 50:50 w/w mixture of ethylene carbonate and diethyl carbonate. Cell assembly was carried out in an Argon-filled glove box with the concentrations of moisture and oxygen below 1 ppm. Charge-discharge cycles of the cells were measured in a fixed voltage window (see main text) at a constant current density with a Maccor 4304 battery tester. Both the C rate and specific capacity were corrected based on the mass of SnO₂@carbon coaxial hollow spheres while excluding possible impurities such as remnant silica and base from elemental analysis. 1C is defined as 625 mA/g for easy denotation.

Analysis

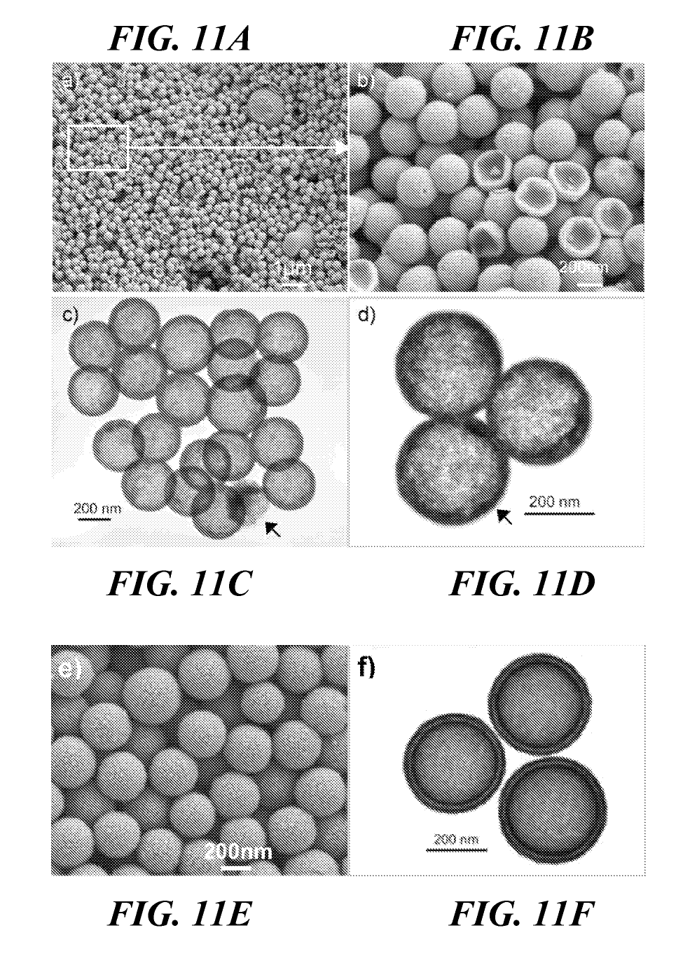

Test results for the hollow spheres of Example 3 and comparative data are set forth in FIGS. 11 to 18. FIG. 11(a)-(d) shows the FESEM (a,b) and TEM (c,d) images of SnO₂@carbon hollow spheres. The arrows in (c) and (d) indicate carbon shells; (e) and (f) show double-shelled SnO₂ hollow spheres. The morphology and microstructure of the as-derived SnO₂@carbon hollow nanospheres with field emission scanning electron microscopy (FESEM) and transmission electron microscopy (TEM). From the FESEM images (FIGS. 11 a, b), it can be clearly observed that the shells of a significant fraction of hollow spheres are collapsed upon template removal, like deflated balloons, but not broken. This effect is likely caused by the contraction stress exerted from the carbon shell due to significant shrinkage of GCP during carbonization. As a result, the carbon shell is tightly attached to the SnO₂ shell (FIGS. 11 c, d), which is beneficial for mechanical reinforcement and for enhancing electronic conduction. By comparison, bare SnO₂ double-shells do not collapse (FIGS. 11 e, f), but one can observe some broken hollow spheres (see supporting information). This observation suggests that such SnO₂@carbon coaxial shells should be quite elastic, which might prove advantageous for improving cycling performance. In addition, closer examination reveals that there are small holes on many SnO₂@carbon hollow spheres created presumably during dissolution of silica templates. Such “nano-portals” are also desirable for enhanced Li ion diffusion, which enhances the charge rate capabilities. Because of its relatively low contrast, the outer carbon layer can be clearly seen from the TEM images (FIGS. 11 c and d) as indicated by arrows. Under optimized conditions, the GCP materials mainly deposit on SnO₂ shells. However, it should be pointed out that formation of some carbon microspheres seems inevitable as observed in FIG. 11a. It is further observed from FIG. 11d that the inner double-shell structure of SnO₂, unlike the bare SnO₂ hollow spheres (see FIG. 11f), appears not so well-defined any more due to shrinkage of GCP shell during carbonization. It follows that the SnO₂ nanoparticles are closely attached onto the flexible carbon shell. Combining a hollow interior space and an elastic buffering shell, such a “breathable” nano-architecture is anticipated to offer great promise for improving cycle life of SnO₂-based anodes.

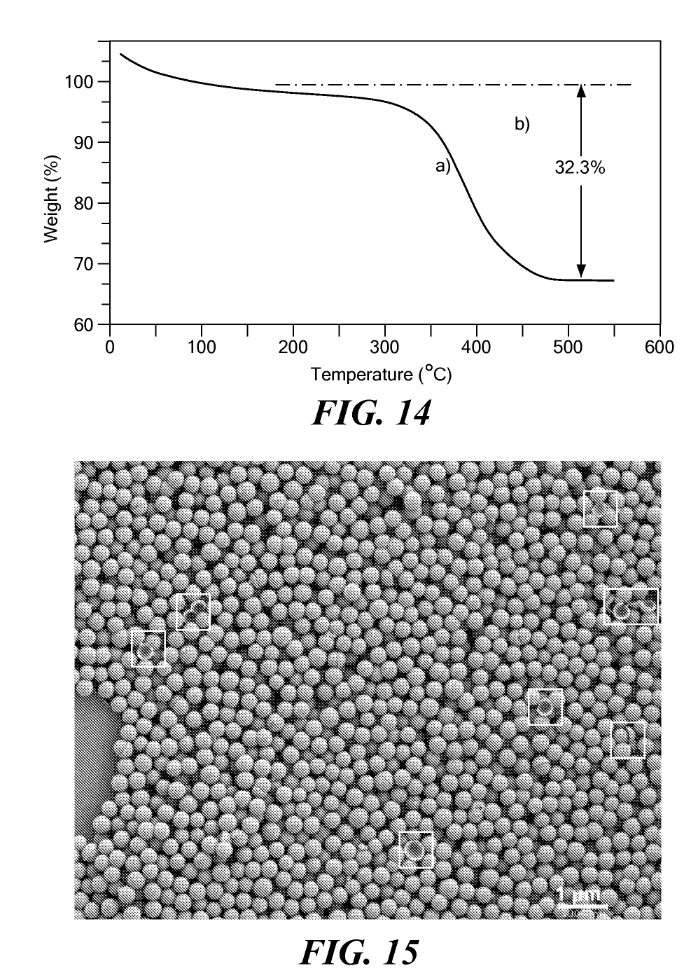

In general, a high-temperature process is required for carbon formation through chemical vapor deposition or carbonization of polymer. This makes it very challenging to prepare nanocomposite SnO₂-carbon anode materials with designed architecture due to carbothermal reduction of SnO₂ forming low-melting-point (232° C.) Sn. In this regard, hydrothermally derived GCP is advantageous because it can be carbonized at a temperature as low as 400° C., while carbothermal reduction of SnO₂ takes place only when the temperature reaches about 600° C. Park et al. Adv. Funct. Mater., 18:455 (2008). As confirmed by x-ray diffraction (XRD) analysis (FIG. 13), no elemental Sn is formed after carbonization at 500° C. while the SnO₂ peaks are only slightly sharpened in comparison with SnO₂ double-shells. The carbon content in these SnO₂@carbon hollow nanospheres can be readily determined by thermo-gravimetric analysis (TGA) to be about 32.3 wt % (FIG. 14).

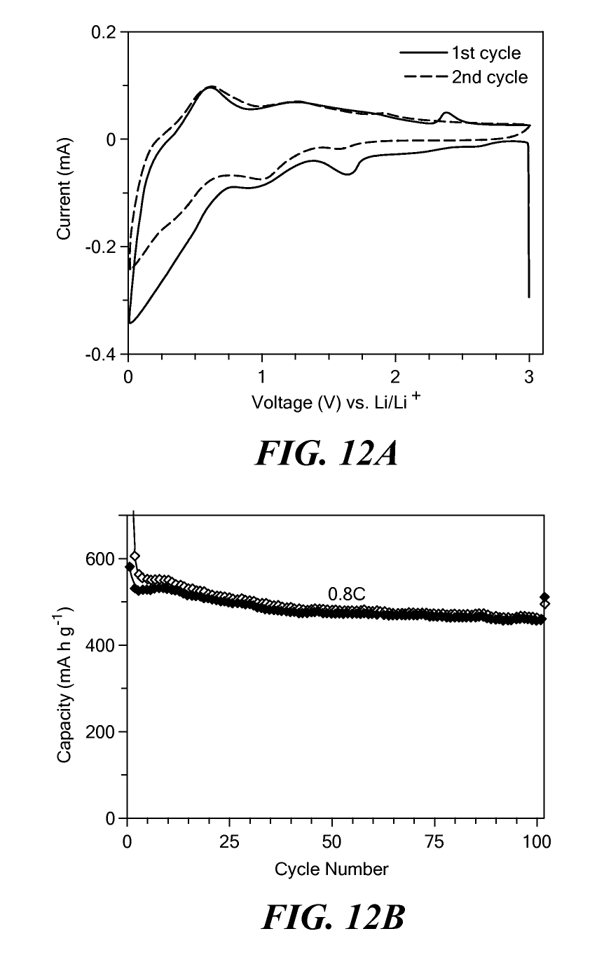

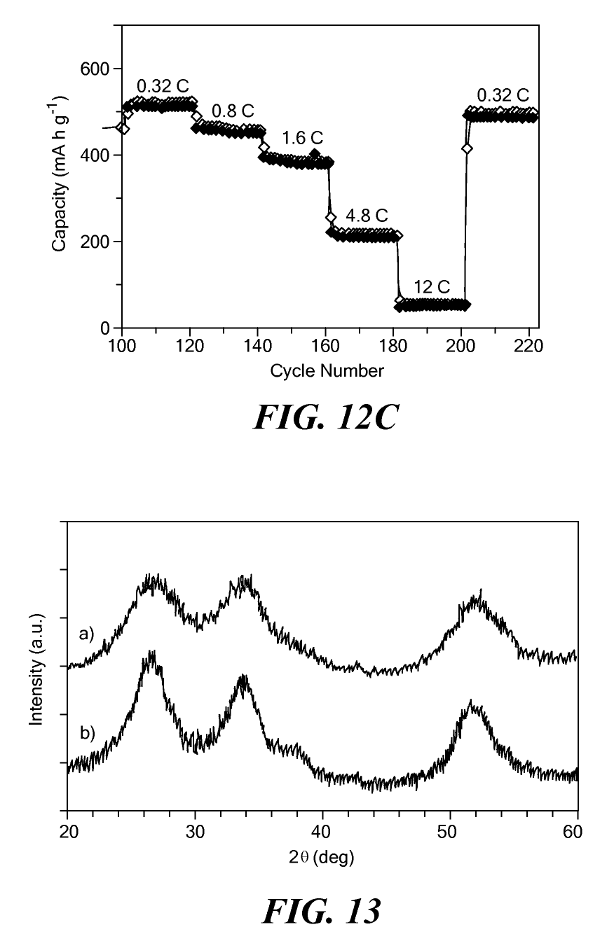

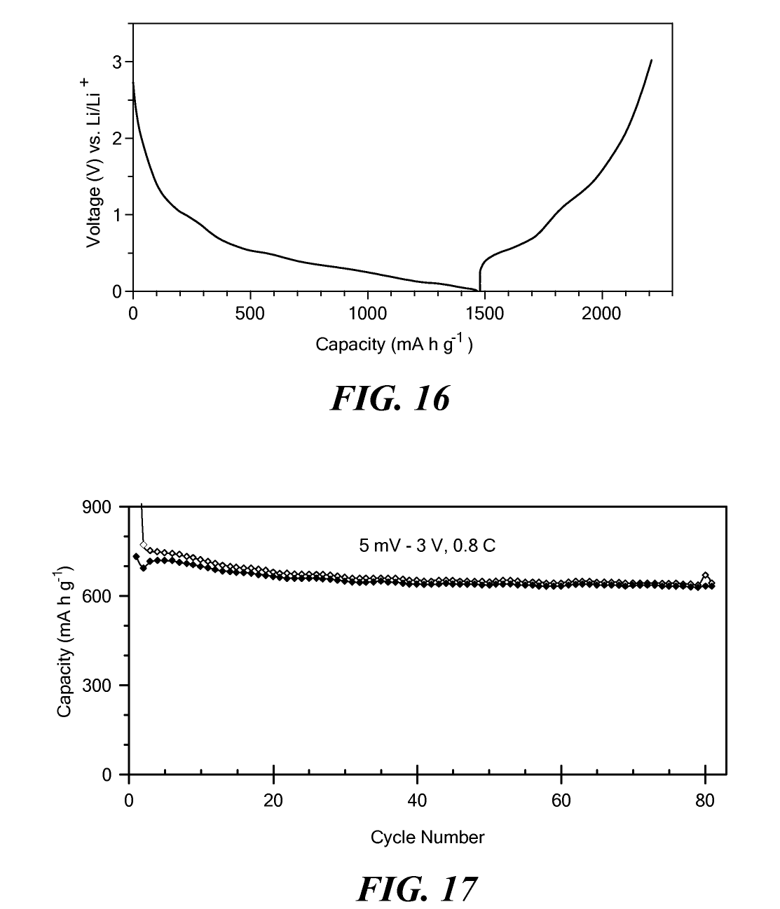

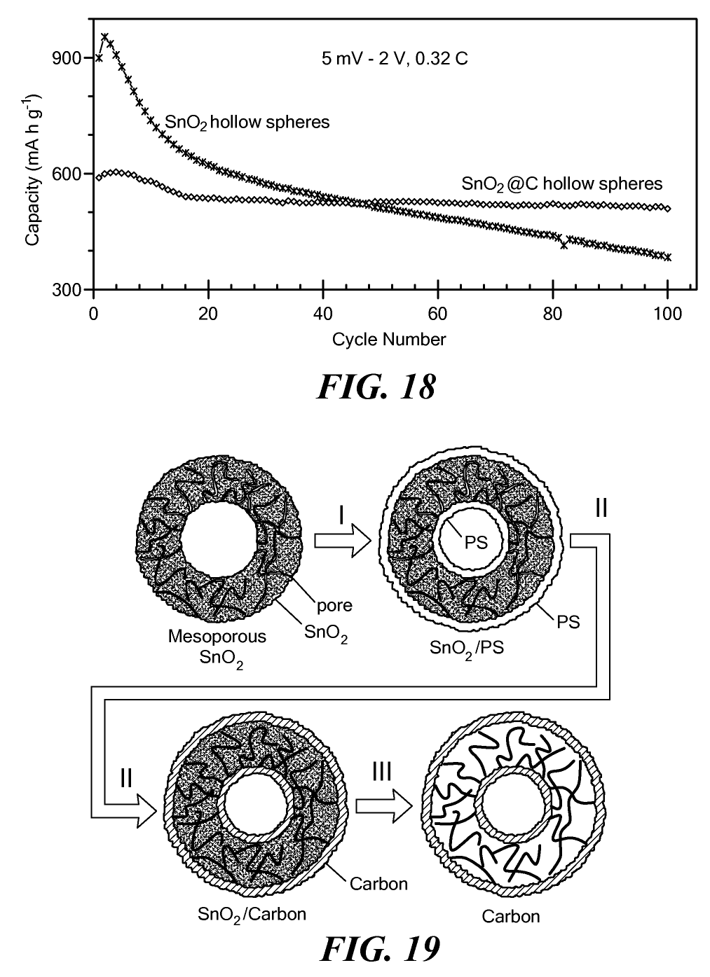

The potential use of these SnO₂@carbon coaxial hollow nanospheres as anode material for lithium-ion batteries was investigated. FIG. 12a shows the cyclic voltammograms (CV) for the first two cycles at a scan rate of 0.05 mV/s in the potential window of 3V-5 mV. The CV behavior is generally consistent with literature, indicating same electrochemical reaction pathway. Demir-Cakan et al, Chem. Mater. 20:1227 (2008). Specifically, three reduction peaks are observed in the first cathodic scan. Two of them are around 1.64 V and 0.98 V, which might be ascribed to formation of solid electrolyte interface (SEI), and reduction of SnO₂ to Sn and Li₂O, respectively. Lytle et al. J. Mater. Chem. 14:161 (2004); Stober et al. J. Colloid Interface Sci. 26:62 (1968). The third dominant peak between 0.6 V and 0 V is known to arise from the formation of LiₓSn alloys. In agreement with this CV result, three poorly defined plateau regions can be identified in the first discharge voltage profile (FIG. 12 (c)). The discharge/charge cycling performance is evaluated between 2 V and 5 mV at a 0.8 C (note that here C does not have the usual meaning but is defined as 625 mA/g in this work for easy denotation) rate up to 100 cycles as shown in FIG. 3b. As expected, these SnO₂@carbon coaxial hollow spheres manifest exceptional cyclability compared to other SnO₂-based anode materials.^{[8, 13, 29]} Specifically, while the capacity decays gradually over the first 30 cycles, it stabilizes around 460 mA h/g for more than 100 cycles. After 100 cycles, the same cell was further evaluated for rate capability as shown in FIG. 12c. When the current rate is first reduced from 0.8 C to 0.32 C, a stable capacity of 520 mA h/g can be achieved. Afterwards, the rate is increased stepwise up to 12 C. As an example, at a high rate of 4.8 C, the hollow spheres can still deliver a stable capacity of about 210 mAh/g. In other words, the discharge or charge process can be finished in about 4 min while still obtaining relatively high capacity. Remarkably, when the current rate is again reduced back to 0.32 C after more than 200 cycles, a stable high capacity of 500 mA h/g can be resumed (FIG. 16). This result might suggest that the elastic hollow structure is indeed very “breathable”. It is well known that the cycling performance is highly dependent on the discharge/charge voltage window employed. In general, the cycling performance will be dramatically reduced with a wider discharge/charge voltage window because of the harsher conditions applied for extraction of lithium. The cycling performance in the voltage window of 3V-5 mV was also examined. Significantly, excellent cycling performance can still be obtained at a 0.8 C rate, giving a stable capacity of about 630 mA h/g after 80 cycles (FIG. 17). Lastly, the cycling performance of these SnO₂@carbon coaxial hollow spheres is compared with that of SnO₂ hollow spheres under identical testing conditions (FIG. 18). Because of the presence of about one-third by mass of barely active amorphous carbon in the SnO₂@carbon, the initial capacity of SnO₂@carbon is about two-third of the capacity of bare SnO₂ sample. In agreement with literature, the capacity of bare SnO₂ hollow spheres fades rapidly to about 69% of the initial capacity after only 20 cycles. After that the capacity decays at a slower but almost constant rate to a value below that of SnO₂@carbon coaxial hollow spheres after about 46 cycles. It nevertheless should be noted that the capacity retention of these SnO₂ hollow spheres is significantly enhanced if compared to other SnO₂ nanostructures because of their large cavity space. Lou et al. Adv. Mater. 18:2325 (2006); Park et al. Adv. Funct. Mater. 20:1227 (2008). The SnO₂@carbon coaxial hollow spheres manifest superior cycling performance, namely, a stable capacity of about 500 mA h/g for at least about 200 cycles. Higher order to cycles are also possible, including about 200, 400, 500, 1000, 10,000 and 100,000.

### Example 4

### Materials Synthesis

Mesoporous SnO₂ hollow nanospheres may also be synthesized as follows. Lou et al. Chem. Mater. 20:6562 (2008). Urea and potassium stannate trihydrate, K₂SnO₃3H₂O (Aldrich, 99.9%) were dissolved in a mixed solvent of ethanol/water (37.5% ethanol by volume) to achieve concentrations of 0.1 M and 16 mM, respectively. Afterwards, the solution was transferred to Teflon-lined stainless steel autoclaves, and hydrothermally treated in an airflow electric oven at 150° C. for 24 hours to produce a white precipitate, which was then harvested by centrifugation and washed with ethanol and deionized water followed by vacuum drying at room temperature. To prepare SnO₂/polysaccharide composite hollow spheres, 0.2 g of as-synthesized mesoporous S1102 hollow nanospheres was dispersed by ultrasonication in 20 mL of 1.0 M aqueous glucose solution. The suspension was transferred to a 40 mL Teflon-lined autoclave, which was then heated in an air-flow electric oven at 180° C. for 3 hours. The product was again harvested by centrifugation and washed with deionized water and ethanol for at least five times. After drying at 50° C., the resulting brown powder was carbonized at 550° C. for 3 hours under inert atmosphere to obtain SnO₂/carbon composite hollow spheres.

Materials Characterization

Products were thoroughly characterized with x-ray powder diffraction (XRD; Scintag PAD X, Cu Kα, λ=1.5406 A), field emission scanning electron microscopy (FESEM; Hitachi S4500), transmission electron microscopy (TEM; JEOL-1200EX, 120 kV, and FEI Tecnai T12, 120 kV). Nitrogen adsorption and desorption isotherm was measured using Micromeritics ASAP 2020 sorptometer.

### Electrochemical Measurement

The electrochemical measurements were carried out using homemade two-electrode cells with lithium metal as the counter and reference electrodes at room temperature. The working electrode consisted of active material (e.g., SnO₂/carbon composite hollow spheres), conductivity agent (carbon black, Super-P), and polymer binder (polyvinylidene difluoride, PYDF, Aldrich) in a weight ratio of around 80:10:10. The electrolyte was 1 M LiPF₆ in a 50:50 w/w mixture of ethylene carbonate and diethyl carbonate. Cell assembly was carried out in an Argon-filled glove box with the concentrations of moisture and oxygen below 1 ppm. Charge-discharge cycles of the cells were measured between 2.0 V and 0.005 V at a constant current density of 100 mA/g based on the active material with a Maccor-Series-2000 battery tester. Similar measurement was also carried out for pure SnO₂ hollow nanospheres at a current rate of 160 mA/g.

### Results

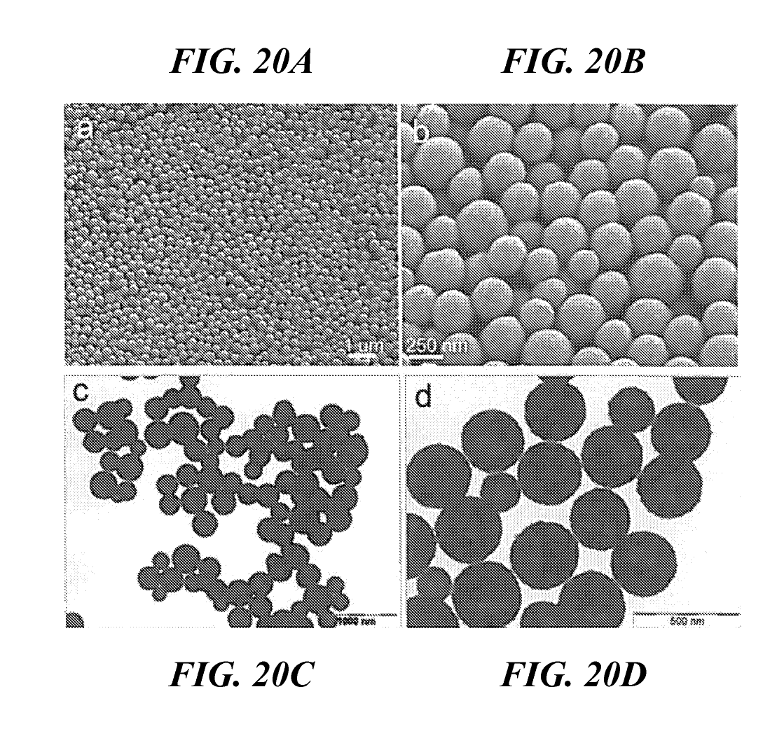

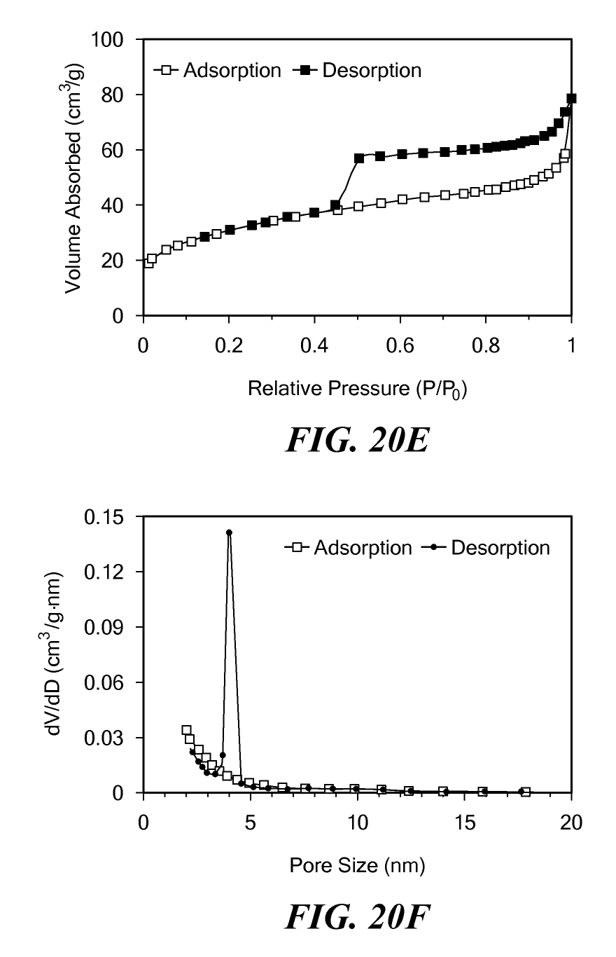

As shown in FIGS. 20(a)-20(d), the mesoporous SnO₂ hollow spheres with size in the range of 150-400 nm are prepared by a template-free route based on an inside-out Ostwald ripening mechanism. Lou et al. Adv. Mater. 20:3987 (2008); Lou et al. Adv. Mater. 18:2325 (2006). Since the hollow interior space is created by spontaneous evacuation of the interior materials through the shell, it follows that the as-formed SnO₂ shell must be highly porous. Here we confirm this structural feature by N₂ sorption measurements. As shown in FIG. 20(e), the N₂ adsorption-desorption isotherm is characteristic of type IV with a relatively unusual type H4 hysteresis loop, which might appear to be a unique characteristic of large pores (the hollow interior) embedded in a matrix with pores of much smaller sizes (the mesoporous shell). Kruk et al. Chem. Mater. 18:3486 (2006). FIG. 20(f) shows the corresponding pore size distributions calculated by the Barrett-Joyner-Halenda (B1H) method from both adsorption and desorption branches. Most notably, there is a sharp peak around 4 nm in the pore size distribution from the desorption branch. In general, pore size distribution from the desorption branch is less reliable and such a sharp peak may be an artifact corresponding to capillary evaporation at the lower end of the hysteresis loop with a relative pressure of about 0.4-0.5. Nonetheless, from the pore size distributions, it can be concluded that the pores are generally smaller than 5 nm. As expected, such a mesoporous structure gives rise to a relatively high Brunauer-Emmett-Teller (BET) specific surface area of about 110 m²/g. The pores may be randomly or evenly distributed on the surface; the pores may also be distributed in one area.

The pores of the SnO₂ shells are large enough to be directly infiltrated with carbon precursor (PS) derived from glucose under hydrothermal conditions. Ikeda et al. Chem. Mater. 19:4335 (2007). Previously this simple method has been employed to coat carbon material on a variety of nanoparticles and to deposit carbon in amino-functionalized silica pores of a few nm. Ikeda et al. Chem. Mater. 19:4335 (2007); Sun et al. Chem. Mater. 18:3486 (2006); Sun et al. Angew. Chem. Int. Ed. 43:597 (2004). Unlike other commonly used polymer carbon precursors (e.g., polyacrylonitrile, PAN), glucose-derived PS enables facile integration of carbon to nanostructure synthesis in solution and most importantly it can be carbonized at a temperature as low as 400° C.

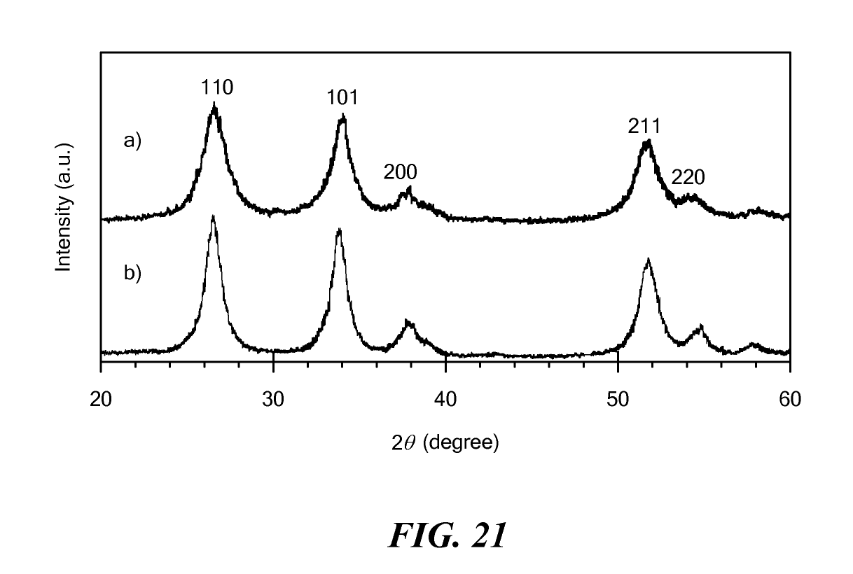

Tin oxide could be carbothermally reduced to metallic tin when the carbonization temperature reaches 600° C. Sun et al. Chem. Mater. 18:3486 (2006). Because of the very low melting temperature of tin (232° C.), it will evaporate once formed at a much higher temperature, which is verified in experiments carried out at temperatures above 600° C. An initial attempt to incorporate carbon networks from a polymer precursor (e.g., PAN) by vapor deposition polymerization was not successful. McCann et al., Nano Lett. 7:2740 (2007); Johnson et al. Science 283:963 (1999). Therefore, in this work, carbonization is carried out at 550° C. to avoid destruction of the nanostructure. As confirmed by x-ray diffraction (XRD) analysis (FIG. 21(b)), no elemental Sn is formed after carbonization at 550° C. while the SnO₂ peaks are slightly sharpened as compared to the XRD pattern of the pristine SnO₂ hollow spheres (FIG. 21(a)).

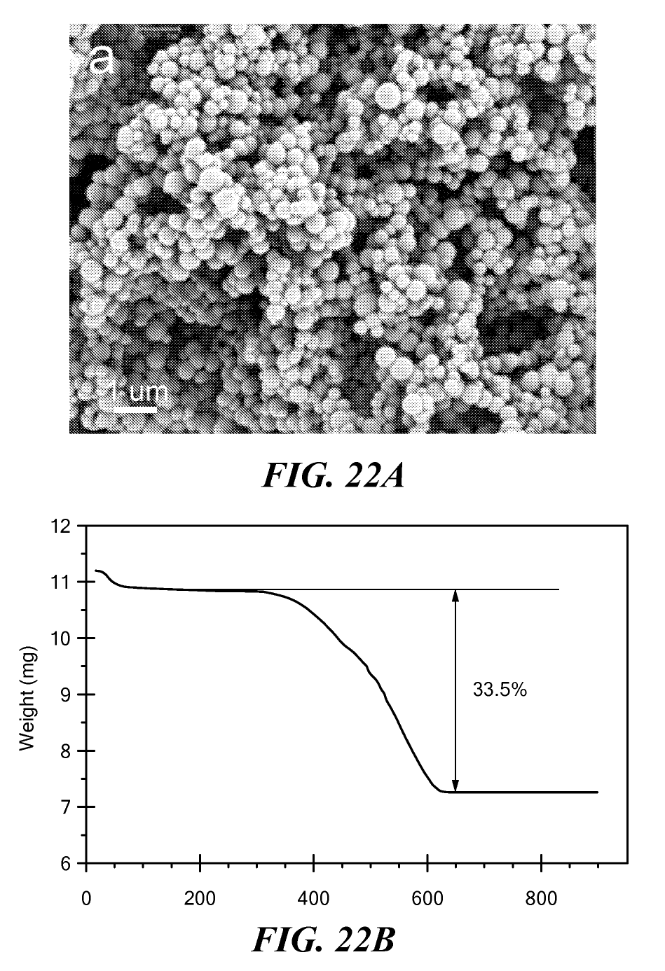

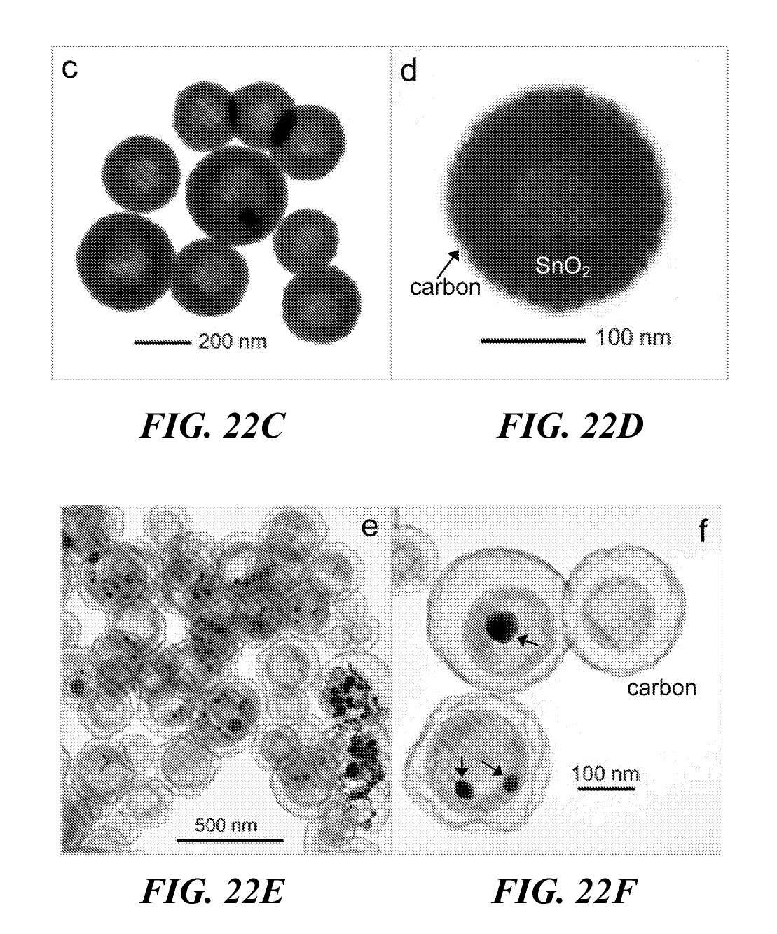

The morphology and microstructure of the as-synthesized SnO₂/carbon nanocomposite are examined with scanning electron microscopy (SEM) and transmission electron microscopy (TEM). From the SEM image shown in FIG. 22(a), the overall morphology of SnO₂/carbon composite is very similar to that of SnO₂ hollow spheres.

To determine the carbon content in the SnO₂/carbon composite, thermogravimetric analysis (TGA) is carried out. FIG. 22(b) shows the TGA curve under air with a temperature ramp of 10° C./min. From the observation that the TGA curve is monotonic, and since the weight loss mainly takes place below 600° C., the possible carbothermal reduction of SnO₂ and re-oxidation of Sn by oxygen can be ruled out. Therefore, the carbon content in the SnO₂/carbon nanocomposite is simply determined to be about 33.5% by weight. The hollow spherical nature of these SnO₂/carbon composite particles is clearly revealed by the low magnification TEM image (FIG. 22(c)) although it is difficult to observe a layer of carbon coating due to the high contrast of the image. FIG. 22(d) shows a TEM image displaying a representative single hollow sphere. From the relative light contrast, it can be clearly observed that a thin carbon layer is coated uniformly on the outer surface of the SnO₂ sphere. It is further proven that the carbon precursor deposits not only on the outer surface but also penetrate into the mesoporous SnO₂ shell. When the particles are irradiated by focused electron beams during the TEM examination, SnO₂ could be reduced to form melted metallic Sn, which could evaporate easily under vacuum. As a result, it is interesting to occasionally observe that double-shelled carbon spheres (FIGS. 22(e) and 22(f)) are formed in-situ upon electron irradiation. Similarly, the mesoporous SnO₂ shells could also be selectively removed by thermal reduction with H₂ and evaporation to prepare the interesting double-shelled carbon hollow spheres as illustrated in FIG. 21, (step III). Lou et al. Adv. Mater. 19:3328 (2007); Yang et al. Angew Chem. Int. Ed. 44:6727 (2005); Lou et al. Small 3:261 (2007). Encapsulated tin nanoparticles can still be observed in some double-shelled hollow spheres (black dots as indicated by black arrows in FIG. 22(f)). Evidently, the observation of the inner carbon shell indicates that the carbon precursor may have infiltrated through the mesoporous SnO₂ shell.

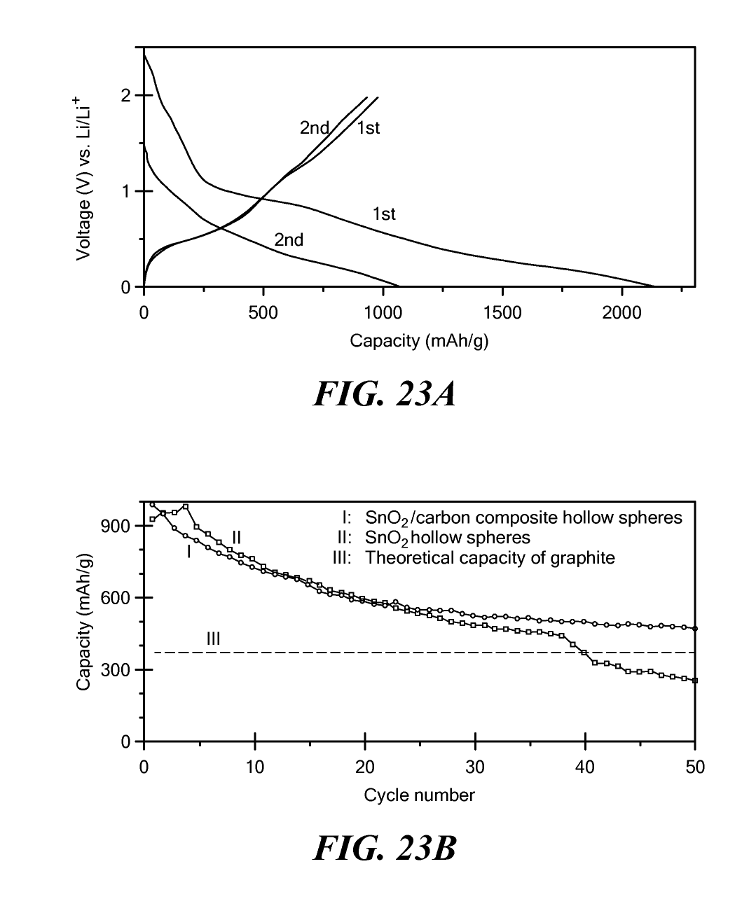

The lithium storage properties of these SnO₂/carbon hollow spheres as a potential anode material for lithium-ion batteries (LIBs) are evaluated using a two-electrode cell, in which SnO₂/carbon serves as the working electrode, and lithium metal serves as the counter and reference electrode. Lou et al. Adv. Mater. 18:2325 (2006). The reaction mechanism for SnO₂/Li cell can be described as follows: SnO₂+4Li¹+4e⁻→Sn+2Li₂O (1); Sn+xLi¹+xe⇄LiₓSn (0≦x≦4.4) (2). Park et al. Angew. Che. Int. Ed. 46:750 (2007); Demir-Cakan et al., Chem Mater. 20:1227 (2008). FIGS. 23(a) and 23(b) show the results in terms of the discharge-charge voltage profiles for the first two cycles and cycling performance (i.e., capacity retention vs. cycle number) at a constant current density of 100 mA/g. The voltage profiles are characteristic of SnO₂-based materials. The initial discharge and charge capacities are 2157 and 983 mA h/g, respectively. This large initial irreversible loss (56.3%) is common for SnO₂ materials, which is attributed to the irreversible reduction of SnO₂ to Sn as described in equation (I) and other possible irreversible processes, such as decomposition of electrolyte to form a protective film on the electrode surface. From the cycling performance plot (FIG. 23(b)), it is important to note that the capacity tends to level off after 30 cycles, and the SnO₂/carbon hollow spheres are able to deliver a reversible Li storage capacity of 473 mAh/g after 50 cycles, which is about 27% higher than the theoretical capacity of graphite (372 mAh/g). For comparison, the lithium storage properties of pure SnO₂ hollow spheres are also characterized under similar conditions and the result is shown in FIG. 23(b). Note that a current density of 160 mA/g is used for pure SnO₂ hollow spheres to take into account the consideration that SnO₂/carbon composite hollow spheres contain about 33.5 wt % of carbon which is barely active for lithium storage, although the effect of current rates in such a moderate range on cycling performance is very limited. In agreement with literature, the capacity of pure SnO₂ anode tends to fade quickly after 30 cycles to a value below 372 mAh/g. It should also be noted that the capacity of the SnO₂/carbon composite anode is comparable to that of SnO₂ in the course of the first 30 cycles, despite the fact that one-third of its mass is composed of low-activity amorphous carbon. This observation suggests that the introduction of a carbon matrix to form a truly mixed nanocomposite increases the utilization efficiency of the active component, and improves the cycle life of Li-metal alloying electrodes by reducing the pulverization problem.

The extent of improvement in capacity retention can be lower than expected due to two factors: carbon materials completely fill in the pores, and the central cavity is too small (in other words, the shell is too thick). By further tailoring the hollow structures of SnO₂, similar concept has nonetheless been successfully applied to prepare composite materials with stable lithium storage capacity retention for cycles ranging from about 100 to about 1000 or greater.

In this example, we have designed a new nanostructured SnO₂/carbon composite anode material with a hollow spherical structure. 3D carbon networks in nanoscale can be effectively integrated into mesoporous S1102 shells by selective infiltration of carbon precursor in solution followed by carbonization. Double-shelled carbon hollow spheres can be obtained by selective removal of the sandwiched mesoporous SnO₂ shells. The carbon networks act as both a physical buffering cushion for the intrinsic large volume change and an electrical conducting path. As a result, the capacity retention of the composite electrode is largely improved. The electrode design presented in this work, combining the nanostructure design and composite concept, should be applicable for preparation of other electrode materials.

The scope of the present invention is not limited by what has been specifically shown and described hereinabove. Numerous references, including patents and various publications, are cited and discussed in the description of this invention. The citation and discussion of such references is provided merely to clarify the description of the present invention and is not an admission that any reference is prior art to the invention described herein. All references cited and discussed in this specification are incorporated herein by reference in their entirety. Variations, modifications and other implementations of what is described herein will occur to those of ordinary skill in the art without departing from the spirit and scope of the invention. While certain embodiments of the present invention have been shown and described, it will be obvious to those skilled in the art that changes and modifications may be made without departing from the spirit and scope of the invention. The matter set forth in the foregoing description and accompanying drawings is offered by way of illustration only and not as a limitation.

What is claimed is:

1. Nano-colloids comprising carbon-coated SnO₂ nano-colloids.

2. The nano-colloids of claim 1 wherein the nano-colloids are monodisperse.

3. The nano-colloids of claim 1 wherein the nano-colloids are polydisperse.

4. The nano-colloids of claim 1 wherein the nano-colloids comprise two carbon shells.

5. The nano-colloids of claim 1 wherein the carbon is derived from a polysaccharide.

6. The nano-colloids of claim 5 wherein the polysaccharide is glucose.

7. The nano-colloids of claim 1 wherein an anode from a Li-ion battery is coated with the nano-colloids.

8. The nano-colloids of claim 1 wherein the nano-colloids are a sphere having a diameter ranging from about 150 nm to about 400 nm.

9. A method of synthesizing SnO₂ nano-colloids, comprising the steps of
(a) dissolving potassium stannate in a glucose solution;
(b) heating the glucose solution to a temperature ranging from about 160° C. to about 200° C. for about 2 hours to about 8 hours to obtain a powder; and
(c) carbonizing the powder by heating to a temperature ranging from about 450° C. to about 700° C. for about 2 hours to about 8 hours.

10. The method of claim 9, wherein carbonizing is done under N₂.

11. The method of claim 9, wherein the glucose solution has a concentration ranging from about 0.2 M to about 1.0 M.

12. The method of claim 11 wherein the glucose solution has a concentration ranging from about 0.5 M to about 0.8 M.

13. Coaxial SnO₂@carbon hollow nanospheres, comprising a hollow SnO₂ shell having an outer shell of carbon.

14. The coaxial SnO₂@carbon hollow nanospheres of claim 13 wherein the carbon is derived from a polysaccharide.

15. The coaxial SnO₂@carbon hollow nanospheres of claim 14 wherein the polysaccharide is glucose.

16. The coaxial SnO₂@carbon hollow nanospheres of claim 13, wherein the SnO₂ shell comprises a double shell of SnO₂.

17. An anode of a Li-ion battery coated with a plurality of the coaxial SnO2@carbon hollow nanospheres of claim 13.

18. A method for making the coaxial SnO2@carbon hollow nanospheres, comprising the steps of:
(a) synthesizing substantially monodisperse silica nanospheres;
(b) coating SnO₂ double-shells on the silica nanospheres;
(c) coating the SnO₂@silica with a polysaccharide;
(d) carbonizing the polysaccharide under an inert atmosphere; and
(e) removing the silica nanospheres by addition of acid or base.

19. The method of claim 18 wherein in step (e) the silica nanospheres are removed by addition of NaOH.

20. The method of claim 18 wherein in step (e) the silica nanospheres are removed by addition of HC1.

21. An anode of a Li-ion battery coated with a plurality of coaxial SnO2@carbon hollow nanospheres formed by the process of claim 18.

22. The method of claim 18 wherein the polysaccharide is glucose.

23. Mesoporous SnO₂ hollow nanospheres having a plurality of pores ranging from about 3 nm to about 5 nm in diameter.

24. The mesoporous SnO₂ hollow nanospheres of claim 22 wherein the pores are about 4 nm in diameter.
